(19) United States
(12) Patent Application Publication
(10) Pub. No.: US 2025/0384560 A1
(43) Pub. Date: Dec. 18, 2025

(54) MODEL CONSTRUCTION METHOD AND APPARATUS, IMAGE SEGMENTATION METHOD AND APPARATUS, DEVICE AND MEDIUM

(71) Applicant: BEIJING ZITIAO NETWORK TECHNOLOGY CO., LTD., Beijing (CN)

(72) Inventors: Jie QIN, Beijing (CN); Jie WU, Beijing (CN); Pengxiang YAN, Beijing (CN); Ming LI, Beijing (CN); Yuxi REN, Beijing (CN); Xuefeng XIAO, Beijing (CN)

(21) Appl. No.: 18/877,709

(22) PCT Filed: Nov. 20, 2023
(86) PCT No.: PCT/CN2023/132560

§ 371 Date: Dec. 20, 2024

(30) Foreign Application Priority Data
Dec. 19, 2022 (CN) 202211634709.8

(51) Int. Cl. G06T 7/11; G06V 10/26; G06V 10/764

(52) U.S. Cl. CPC G06T 7/11; G06V 10/26; G06V 10/764

(57) ABSTRACT

The present application discloses a model construction method and apparatus, an image segmentation method and apparatus, a device and a medium, to improve the effect of image segmentation. The method includes: first training a mask extractor using a training dataset and mask labels that the training dataset has in several image segmentation tasks, so that the trained mask extractor has a good effect of mask extraction under all these image segmentation tasks. Thus, an image segmentation model constructed using the trained mask extractor has a good effect of image segmentation under all these image segmentation tasks.

### CROSS-REFERENCE TO RELATED APPLICATION(S)

The present application claims priority to Chinese Patent Application No. 202211634709.8, filed with the China National Intellectual Property Administration on Dec. 19, 2022 and entitled “MODEL CONSTRUCTION METHOD AND APPARATUS, IMAGE SEGMENTATION METHOD AND APPARATUS, AND DEVICE AND MEDIUM”, the disclosure of which has been incorporated herein by reference in its entirety.

### FIELD

The present application relates to the technical field of image processing, and in particular to a model construction method and apparatus, an image segmentation method and apparatus, a device and a medium.

### BACKGROUND

Image segmentation is a widely researched technique in the technical field of computer vision, and the objective of image segmentation is to simultaneously group and classify pixels of objects in a piece of image data.

However, due to the defects of some model construction schemes in the field of image segmentation, the effect of image segmentation of image segmentation models constructed using these model construction schemes is not so good.

### SUMMARY

The present application provides a model construction method and apparatus, an image segmentation method and apparatus, a device and a medium that are capable of improving the effect of image segmentation.

In order to achieve the above objective, the technical solutions provided in the present application are as follows.

The present application provides a model construction method. The method includes:
determining an image to be processed from a training dataset, the training dataset including at least one first image that includes the image to be processed;
determining a first visual feature and a first mask extraction result of the image to be processed using a mask extractor;
determining a mask prediction loss based on the first mask extraction result and a mask label corresponding to the image to be processed;
determining a class prediction loss based on a similarity matching map between the first visual feature and a text embedding feature corresponding to the image to be processed, and a class label corresponding to the image to be processed, wherein the text embedding feature is determined based on a task identifier of the image to be processed and a class label corresponding to the at least one first image; and
updating the mask extractor based on the mask prediction loss and the class prediction loss, and continuing to perform the step of determining an image to be processed from the training dataset until a first stopping condition is met, and determining an image segmentation model based on the mask extractor.

In a possible implementation, the mask label corresponding to the image to be processed is determined based on the task identifier of the image to be processed; and the task identifier of the image to be processed is determined from task identifiers of several image segmentation tasks.

In a possible implementation, the mask extractor includes an encoding network and a decoding network, the decoding network including a first decoding module, a second decoding module, and a prediction module; and
determining the first visual feature and the first mask extraction result of the image to be processed using the mask extractor includes:
inputting the image to be processed into the mask extractor to obtain an encoding result output by the encoding network in the mask extractor;
inputting the encoding result into the first decoding module to obtain a feature to be processed that is output by the first decoding module;
performing semantic and contextual interaction on the feature to be processed and the text embedding feature to obtain the first visual feature of the image to be processed; and
determining the first mask extraction result of the image to be processed based on the first visual feature of the image to be processed, the second decoding module, and the prediction module.

In a possible implementation, performing the semantic and contextual interaction on the feature to be processed and the text embedding feature to obtain the first visual feature of the image to be processed includes:
performing the semantic and contextual interaction on the feature to be processed and the text embedding feature using a pre-constructed cross-attention module to obtain the first visual feature of the image to be processed.

In a possible implementation, the text embedding feature corresponding to the image to be processed is determined based on a text feature extraction module, the task identifier of the image to be processed, and the class label corresponding to the at least one first image; and
determining the image segmentation model based on the mask extractor includes:
determining the image segmentation model based on the mask extractor and the text feature extraction module.

In a possible implementation, the text feature extraction module includes a prompt information generation network and a preset text encoder; and the class label corresponding to the at least one first image includes at least one class label to be processed; and a process of determining the text embedding feature corresponding to the image to be processed includes:
inputting the task identifier of the image to be processed into the prompt information generation network to obtain task prompt information that is output by the prompt information generation network;
inputting each class label to be processed into the prompt information generation network to obtain class prompt information corresponding to the class label to be processed that is output by the prompt information generation network;
inputting the task prompt information into the preset text encoder to obtain a task embedding feature output by the preset text encoder;
inputting the class prompt information corresponding to the class label to be processed into the preset text encoder to obtain a class embedding feature corresponding to the class label to be processed that is output by the preset text encoder;
concatenating the class embedding feature corresponding to the class label to be processed with the task embedding feature to obtain a concatenated result corresponding to the class label to be processed; and
determining the text embedding feature corresponding to the image to be processed based on the concatenated result corresponding to the at least one class label to be processed.

In a possible implementation, the text feature extraction module includes a prompt information generation network and a preset text encoder; and after determining the image segmentation model based on the mask extractor and the text feature extraction module, the method further includes:
determining an image to be used from a test dataset, the test dataset including at least one second image that includes the image to be used;
determining, using the image segmentation model, a second mask extraction result of the image to be used and a text embedding feature corresponding to the image to be used;
determining a second visual feature of the image to be used based on the image to be used, the second mask extraction result, and a preset visual encoder;
determining an entropy loss based on a similarity matching map between the second visual feature and the text embedding feature corresponding to the image to be used, and at least one new class label, wherein the at least one new class label is determined based on a result of a comparison between the class label corresponding to the at least one first image and a class label corresponding to the at least one second image; and updating the prompt information generation network in the image segmentation model based on the entropy loss, and continuing to perform the step of determining an image to be used from a test dataset until a second stopping condition is met.

In a possible implementation, the second mask extraction result includes region representation results of several mask regions; and a process of determining the second visual feature of the image to be used includes:
extracting a mask region image corresponding to each mask region from the image to be used based on a region representation result of the mask region; and
inputting mask region images corresponding to the several mask regions into the preset visual encoder to obtain the second visual feature output by the preset visual encoder.

In a possible implementation, the second mask extraction result includes region representation results of several mask regions; and
a process of determining the entropy loss includes:
obtaining through filtering a similarity value corresponding to each new class label from the similarity matching map between the second visual feature and the text embedding feature corresponding to the image to be used to obtain a similarity set corresponding to each mask region, wherein the similarity set is used to record a similarity value corresponding to the mask region of each new class label;
determining an entropy value corresponding to each mask region based on the similarity set corresponding to the mask region;
selecting at least one target region from the several mask regions based on entropy values corresponding to the several mask regions, wherein an entropy value corresponding to the target region satisfies a preset entropy value condition; and
determining the entropy loss based on a similarity set corresponding to the at least one target region.

In a possible implementation, the class prediction loss is determined based on a cross-entropy loss between the similarity matching map and the class label corresponding to the image to be processed.

The present application provides an image segmentation method. The method includes:
obtaining an image to be segmented, a class label corresponding to the image to be segmented, and a pre-constructed image segmentation model, wherein the image segmentation model includes a text feature extraction module and a mask extractor; and the image segmentation model is configured to perform image segmentation for image data under several image segmentation tasks;
determining a text embedding feature corresponding to the image to be segmented using the text feature extraction module, a task identifier of the image to be segmented, and the class label corresponding to the image to be segmented, wherein task identifiers of the several image segmentation tasks include the task identifier of the images to be segmented;
determining a third mask extraction result of the image to be segmented using the mask extractor, the text embedding feature corresponding to the image to be segmented, and the image to be segmented; and
determining a segmentation result of the image to be segmented based on the third mask extraction result.

The present application provides a model construction apparatus, including:
a first determination unit configured to determine an image to be processed from a training dataset, the training dataset including at least one first image that includes the image to be processed;
a second determination unit configured to determine a first visual feature and a first mask extraction result of the image to be processed using a mask extractor;
a third determination unit configured to determine a mask prediction loss based on the first mask extraction result and a mask label corresponding to the image to be processed;
a fourth determination unit configured to determine a class prediction loss based on a similarity matching map between the first visual feature and a text embedding feature corresponding to the image to be processed, and a class label corresponding to the image to be processed, wherein the text embedding feature is determined based on a task identifier of the image to be processed and a class label corresponding to the at least one first image;
a first update unit configured to update the mask extractor based on the mask prediction loss and the class prediction loss, and return to the first determination unit to continue to perform the step of determining an image to be processed from a training dataset; and
a fifth determination unit configured to determine an image segmentation model based on the mask extractor when a first stopping condition is met.

The present application provides an image segmentation apparatus, including:
an object obtaining unit configured to obtain an image to be segmented, a class label corresponding to the image to be segmented, and a pre-constructed image segmentation model, wherein the image segmentation model includes a text feature extraction module and a mask extractor; and the image segmentation model is configured to perform image segmentation for image data under several image segmentation tasks;
a feature determination unit configured to determine a text embedding feature corresponding to the image to be segmented using the text feature extraction module, a task identifier of the image to be segmented, and the class label corresponding to the image to be segmented, wherein task identifiers of the several image segmentation tasks include the task identifier of the images to be segmented;
a mask determination unit configured to determine a third mask extraction result of the image to be segmented using the mask extractor, the text embedding feature corresponding to the image to be segmented, and the image to be segmented; and
a result determination unit configured to determine a segmentation result of the image to be segmented based on the third mask extraction result.

The present application provides an electronic device. The device includes: a processor and a memory, where
the memory is configured to store instructions or a computer program; and
the processor is configured to execute the instructions or the computer program in the memory to cause the electronic device to execute the model construction method or the image segmentation method according to the present application.

The present application provides a computer-readable medium, wherein the computer-readable medium stores instructions or a computer program that, when run on a device, cause the device to execute the model construction method or the image segmentation method according to the present application.

The present application provides a computer program product, which includes a computer program carried on a non-transitory computer-readable medium, wherein the computer program includes program code for executing the model construction method or the image segmentation method according to the present application.

### BRIEF DESCRIPTION OF THE DRAWINGS

In order to more clearly describe the technical solutions in the embodiments of the present application or in the prior art, the drawings for describing the embodiments or the prior art will be briefly described below. Apparently, the drawings in the description below show merely some embodiments recited in the present application, and persons of ordinary skill in the art may still derive other drawings from these drawings without creative efforts.

FIG. 1 is a flowchart of a model construction method according to an embodiment of the present application;

FIG. 2 is a schematic diagram of a framework of an image segmentation model according to an embodiment of the present application;

FIG. 3 is a schematic diagram of a structure of a mask extractor according to an embodiment of the present application;

FIG. 4 is a flowchart of an image segmentation method according to an embodiment of the present application;

FIG. 5 is a schematic diagram of a structure of a model construction apparatus according to an embodiment of the present application;

FIG. 6 is a schematic diagram of a structure of an image segmentation apparatus according to an embodiment of the present application; and

FIG. 7 is a schematic diagram of a structure of an electronic device according to an embodiment of the present application.

### DETAILED DESCRIPTION OF EMBODIMENTS

It has been found through research that some model construction schemes in the field of image segmentation comprise at least the following defects. Since an image segmentation model constructed using these model construction schemes can typically only accomplish one image segmentation task (e.g., a semantic segmentation task), the image segmentation model presents a relatively poor effect of image segmentation under other image segmentation tasks.

Based on the above findings, in order to better improve the effect of image segmentation, the present application provides a model construction method and an image segmentation method, as follows. Specifically, for several image segmentation tasks (e.g., semantic segmentation, instance segmentation, and panoptic segmentation, among other tasks) in the field of image segmentation, a mask extractor is first trained using a training dataset and mask labels that the training dataset has in the image segmentation tasks, so that the trained mask extractor has a good effect of mask extraction under all these image segmentation tasks. Thus, an image segmentation model constructed using the trained mask extractor has a good effect of image segmentation under all these image segmentation tasks, which in turn makes the image segmentation model suitable for image segmentation for image data under these image segmentation tasks. This makes the image segmentation model have a multi-image segmentation task processing function, so that the objective of completing multiple image segmentation tasks using one model can be achieved, so that the image segmentation model can be subsequently used to perform image segmentation for image data under multiple image segmentation tasks. This can effectively improve the generalization performance of the image segmentation model, and thus can effectively overcome the defects existing in the aforementioned model construction scheme, thereby effectively improving the effect of image segmentation of the image segmentation model.

In addition, the executing entity for the aforementioned model construction method is not limited by the present application. For example, the model construction method according to an embodiment of the present application may be applied to a device having a data processing function, such as a terminal device or a server. For another example, the model construction method according to an embodiment of the present application may also be implemented with the data communication process between the terminal device and the server. The terminal device can be a smart phone, a computer, a personal digital assistant (PDA), or a tablet computer, among others. The server can be a stand-alone server, a cluster server, or a cloud server.

In addition, the executing entity for the aforementioned image segmentation method is not limited by the present application. For example, the image segmentation method according to an embodiment of the present application may be applied to a device having a data processing function, such as a terminal device or a server. For another example, the image segmentation method according to an embodiment of the present application may also be implemented with the data communication process between the terminal device and the server.

In order for those skilled in the art to better understand the solutions of the present application, the technical solutions in the embodiments of the present application will be described below clearly and completely with reference to the accompanying drawings in the embodiments of the present application. Apparently, the embodiments described are merely some rather than all of the embodiments of the present application. All other embodiments obtained by persons of ordinary skill in the art based on the embodiments of the present application without creative efforts fall within the scope of protection of the present application.

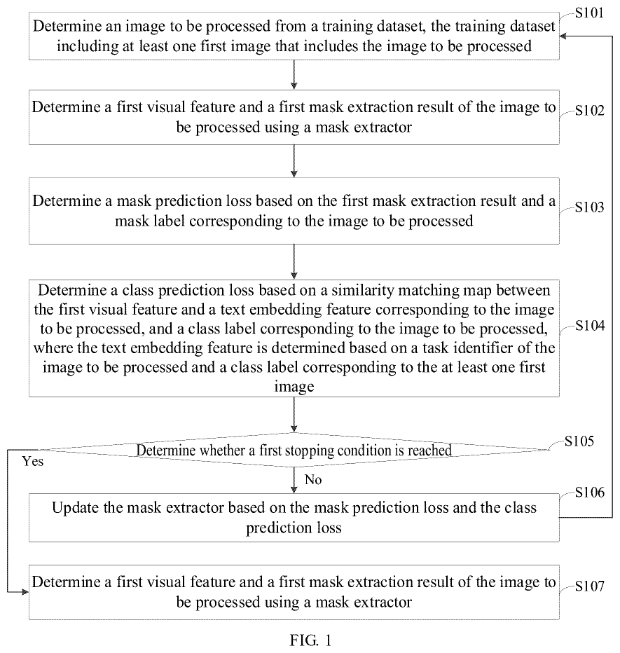

For a better understanding of the technical solutions provided in the present application, the model construction method according to the present application is first described below in conjunction with the accompanying drawings. As shown in FIG. 1, the model construction method according to an embodiment of the present application includes the following S101 to S107. FIG. 1 is a flowchart of a model construction method according to this embodiment of the present application.

S101: Determine an image to be processed from a training dataset, the training dataset including at least one first image that includes the image to be processed.

The training dataset is an image dataset that needs to be used in a training process. Furthermore, the training dataset is not limited by the present application, and may be implemented using, for example, any existing or future training dataset that can participate in the training process for the image segmentation model.

In fact, the aforementioned training dataset may at least include at least one first image, so that the model training process can subsequently be completed with the aid of these first images. The first image is image data that needs to be used in the training process.

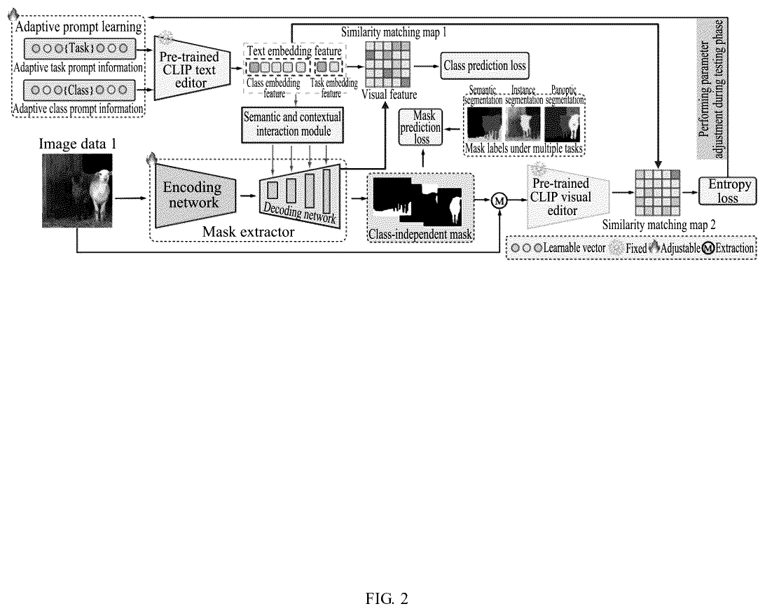

The image to be processed is image data that needs to be used during the current round of training process. Furthermore, the image to be processed is not limited by the present application, and may be, for example, any one of the first images recorded in the aforementioned training dataset. For example, the image to be processed may be image data 1 shown in FIG. 2.

In addition, the implementation of the aforementioned S101 is not limited by the present application. For example, S101 may be implemented using any existing or future implementation method for obtaining image data that may be employed during each round of training process.

S102: Determine a first visual feature and a first mask extraction result of the image to be processed using a mask extractor.

The mask extractor is configured to perform mask extraction for a piece of image data. Furthermore, the mask extractor is not limited by the present application, and may be implemented using, for example, any existing or future model with a mask extraction function. For another example, the mask extractor may be implemented using the mask extractor shown in FIG. 2.

In addition, a model structure of the aforementioned mask extractor is not limited by the present application. For example, the mask extractor may include an encoding network (e.g., an encoding network shown in FIG. 2) and a decoding network (e.g., a decoding network shown in FIG. 2), and the input data of the decoding network includes the output data of the encoding network.

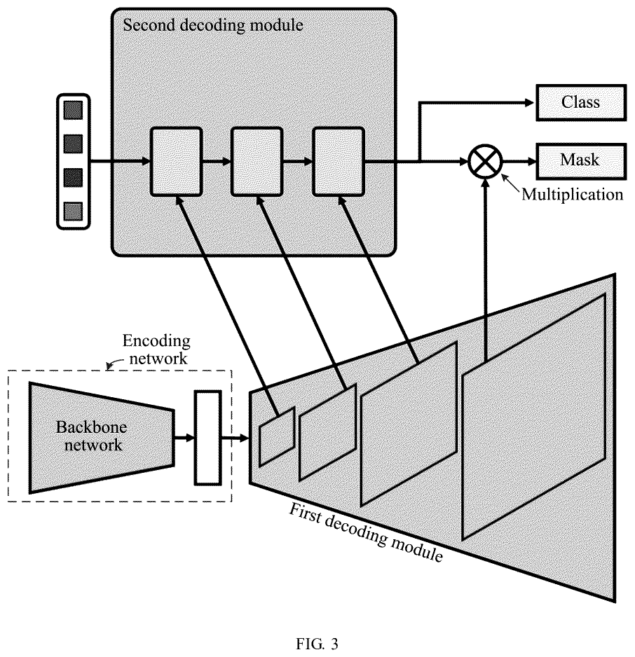

The aforementioned “encoding network” is configured to perform encoding for the input data of the encoding network. Furthermore, the encoding network is not limited by the present application, and may be implemented using, for example, an encoding network (e.g., an encoding network implemented based on a backbone network as shown in FIG. 3) used in any existing or future mask extractor.

The aforementioned “decoding network” is configured to perform decoding for the input data of the decoding network. Furthermore, the decoding network is not limited by the present application, and may be implemented using, for example, a decoding network used in any existing or future mask extractor. For another example, in a possible implementation, the decoding network includes a first decoding module (e.g., the first decoding module shown in FIG. 3), a second decoding module (e.g., the second decoding module shown in FIG. 3), and a prediction module (e.g., a module for implementing the multiplication shown in FIG. 3).

It should be noted that the aforementioned first decoding module is not limited by the present application, and may be, for example, implemented using a pixel decoder. In addition, the aforementioned second decoding module is not limited by the present application, and may be, for example, implemented using a transformer decoder. Furthermore, the aforementioned prediction module is not limited by the present application, and may be implemented using, for example, a feature multiplication approach (e.g., the multiplication shown in FIG. 3).

The aforementioned “first visual feature of the image to be processed” is the visual feature generated during the mask extraction process for the image to be processed, so that the “first visual feature of the image to be processed” can represent the visual information carried in the image to be processed. For example, when the aforementioned image to be processed is the image data 1 shown in FIG. 2, the first visual feature may be the visual feature output by the decoding network in the aforementioned mask extractor, as shown in FIG. 2.

In addition, the process of determining the aforementioned first visual feature is not limited by the present application, and may be implemented using, for example, a visual feature extraction method involved in any existing or future mask extractor.

It has been found through research that for the mask extractor shown in FIG. 3, the visual feature output by the first decoding module (e.g., the pixel decoder) in the mask extractor may generally ignore task information and class information, which, however, can provide some relatively reliable clues for the comprehensive inference process.

It can be seen from the findings in the preceding paragraph that, in order to better improve the effect of mask extraction of the aforementioned mask extractor, the present application further provides a possible implementation of the mask extractor. In this implementation, when the mask extractor includes an encoding network and a decoding network, and the decoding network includes a first decoding module, a second decoding module, and a prediction module, the decoding network in the mask extractor has the working principle shown in steps 11 to 14 below. For ease of understanding, a possible implementation of the aforementioned S102 is illustrated below as an example

As an example, in a possible implementation, the aforementioned S102 may specifically include steps 11 to 14 below.

Step 11: Input the image to be processed into the mask extractor to obtain an encoding result output by the encoding network in the mask extractor.

In the present application, for the mask extractor, when the mask extractor includes an encoding network and a decoding network, and the input data of the decoding network includes the output data of the encoding network, after the image to be processed (e.g., the image data 1 shown in FIG. 2) is input into the mask extractor, encoding can be performed by the encoding network in the mask extractor on the image to be processed to obtain an encoding result corresponding to the image to be processed, so that the encoding result can relatively well represent the image information carried in the image to be processed.

Step 12: Input the aforementioned encoding result into the first decoding module to obtain a feature to be processed that is output by the first decoding module.

The feature to be processed is the result of the first decoding (e.g., the decoding result based on the pixel decoder) for the encoding result corresponding to the aforementioned image to be processed, so that the feature to be processed can represent the visual information carried in the image to be processed.

In addition, the aforementioned feature to be processed is not limited by the present application. For example, when the aforementioned first decoding module includes Z network layers, the feature to be processed may include a first-layer visual feature output by a first network layer, a first-layer visual feature output by a second network layer, . . . , (in a similar fashion), and a first-layer visual feature output by a Z^{th} network layer, wherein Z is a positive integer and Z denotes the number of network layers present in the first decoding module. In addition, Z is not limited by the present application. For example, when the first decoding module is the first decoding module shown in FIG. 3, Z is 4.

Based on the content related to the aforementioned step 12, it can be seen that, for the mask extractor, when the mask extractor includes an encoding network and a decoding network and the decoding network includes a first decoding module, a second decoding module, and a prediction module, after the decoding network receives the encoding result output by the encoding network with respect to the aforementioned image to be processed, the encoding result is processed by each network layer within the first decoding module in the decoding network to obtain the visual feature output by each network layer in the first decoding module, and the visual features output by these network layers are regarded as the feature to be processed that is output by the first decoding module, so that the feature to be processed can represent the visual information carried in the image to be processed.

Step 13: Perform semantic and contextual interaction on the aforementioned feature to be processed and the text embedding feature corresponding to the aforementioned image to be processed to obtain the first visual feature of the image to be processed.

The aforementioned “text embedding feature corresponding to the image to be processed” is used to describe the task information and the class information corresponding to the image to be processed. For example, when the image to be processed is the image data 1 shown in FIG. 2, the “text embedding feature corresponding to the image to be processed” can be the text embedding feature shown in FIG. 2.

In fact, during the model training process, the aforementioned “text embedding feature corresponding to the image to be processed” is determine based on the task identifier of the image to be processed and the class label corresponding to the aforementioned at least one first image (i.e., all the class labels involved in the aforementioned training dataset) so that the “text embedding feature corresponding to the image to be processed” can represent the task information and the class information corresponding to the image to be processed.

The aforementioned “task identifier of the image to be processed” is used to uniquely identify an image segmentation task corresponding to the image to be processed. Furthermore, the implementation of the “task identifier of the image to be processed is not limited by the present application,” and may specifically be, for example: a task name of the image segmentation task corresponding to the image to be processed.

In addition, the process of determining the aforementioned “task identifier of the image to be processed” is not limited by the present application, and may specifically be, for example: determining the task identifier of the image to be processed from task identifiers of several image segmentation tasks. The task identifier of a gth image segmentation task is used to uniquely identify the gth image segmentation task, wherein g is a positive integer, g≤G, G denoting the number of tasks in the several image segmentation tasks (e.g., as shown in FIG. 2, G=3).

It should be noted that the implementation of the step of “determining the task identifier of the image to be processed from task identifiers of several image segmentation tasks” in the preceding paragraph is not limited by the present application, and may specifically be, for example: selecting one identifier at random from the task identifiers of the several image segmentation tasks and determining the identifier as the task identifier of the image to be processed. For another example, it may specifically be: looking up the task identifier corresponding to the image to be processed from a pre-constructed first mapping relationship, wherein the first mapping relationship is used to record a task identifier of the image segmentation task corresponding to each of the first images.

The class label corresponding to an fth first image is class a priori information pre-determined for the fth first image. Furthermore, the process of determining the “class label corresponding to the fth first image” is not limited by the present application, and can be implemented by means of, for example, manual labeling. f is a positive integer, f≤F, and F is a positive integer and F denotes the number of images in the aforementioned “at least one first image”.

Based on the content related to the aforementioned “text embedding feature corresponding to the image to be processed”, it can be seen that since the text embedding feature is determined based on the task identifier of the image to be processed and all the class labels involved in the aforementioned training dataset, the text embedding feature can relatively well represent the task information and the class information corresponding to the image to be processed, so that the decoding process for the aforementioned image to be processed can be completed using the task information and the class information corresponding to the image to be processed based on the text embedding feature, thereby contributing to improving the decoding effect.

In addition, the process of determining the aforementioned “text embedding feature corresponding to the image to be processed” is not limited by the present application, and may specifically be, for example: determining the text embedding feature corresponding to the image to be processed based on the text feature extraction module, the task identifier of the image to be processed, and the class label corresponding to the aforementioned at least one first image. The text feature extraction module is configured to perform feature extraction for any one piece of text data. Furthermore, the implementation of the text feature extraction module is not limited by the present application.

It has been found through research that in some application scenarios, the effect of text representation can be improved based on an adaptive prompt learning approach. Based on this, the present application further provides a possible implementation of the aforementioned “text feature extraction module”. In this implementation, the text feature extraction module may specifically include a prompt information generation network and a preset text encoder, and the input data of the preset text encoder includes output data of the prompt information generation network.

The aforementioned “prompt information generation network” is used to generate prompt information (e.g., the prompt information shown in (1) below) corresponding to a piece of text data (e.g., text data such as a task identifier or a class label), so that the prompt information carries not only the text data, but also some or all of the network parameters of the prompt information generation network, so that the prompt information can be adjusted and updated accordingly with the parameter adjustment and updating process for the prompt information generation network, thus enabling the prompt information to become a learnable vector. This can better improve the effect of text representation of the prompt information. It should be noted that, for the parameter adjustment and updating process for this prompt information generation network, reference can be made to steps 41 to 47 below, which will not be repeated herein for the sake of brevity.

$${P}_{text} = \{ o , o , o , ... , text , ... , o , o , o \} \qquad ( 1 )$$

In the formula, Pₜₑₓₜ denotes prompt information corresponding to a piece of text information text; text denotes a piece of text information (e.g., text such as a task identifier or a class label); and different 0 denotes different network parameters present in the aforementioned prompt information generation network, and this 0 is learnable. It should be noted that the network parameters involved in {0, 0, 0, . . . , text, . . . , 0, 0, 0} may be all the network parameters in the prompt information generation network or some of the network parameters in the prompt information generation network, and is not specifically limited in the present application.

The aforementioned “preset text encoder” is a pre-constructed network having a text encoding function. Furthermore, the “preset text encoder” is not limited by the present application, and may be, for example, a pre-trained text encoder based on contrastive language-image pre-training (CLIP) (hereinafter referred to as the “pre-trained CLIP text editor”). Furthermore, the pre-trained CLIP text encoder has the working principle shown in Equation (2) below.

$${E}_{text} = ψ ( {P}_{text} ) \qquad ( 2 )$$

In the formula, Eₜₑₓₜ denotes the result of encoding corresponding to a piece of text information text; Pₜₑₓₜ denotes prompt information corresponding to the text information text; text denotes a piece of text information (e.g., a task identifier or a class label); and ψ ( ) denotes an embedding processing function.

In order to better understand the working principle of the aforementioned “text feature extraction module”, the process of determining the aforementioned “text embedding feature corresponding to the image to be processed” is illustrated below as an example.

As an example, when the aforementioned “text feature extraction module” includes a prompt information generation network and a preset text encoder, and the aforementioned “class label corresponding to the at least one first image” includes at least one class label to be processed (i.e., all the classes involved in the aforementioned training dataset), the process of determining the aforementioned “text embedding feature corresponding to the image to be processed” may specifically include the following steps 21 to 26.

Step 21: Input the task identifier of the image to be processed into the prompt information generation network to obtain task prompt information that is output by the prompt information generation network.

The task prompt information is used to represent the task information carried in the task identifier of the aforementioned image to be processed, so that the task prompt information can well represent which kind of image segmentation task the image to be processed belongs to.

In addition, the aforementioned task prompt information is not limited by the present application. For example, when the aforementioned “task identifier of the image to be processed” is the string “task”, and the aforementioned prompt information generation network is implemented using the working principle shown in the aforementioned Equation (1), the task prompt information corresponding to the image to be processed may be Pₜₐₛₖ={0, 0, 0, . . . , task, . . . , 0, 0, 0}, which is adaptive task prompt information.

Step 22: Input each class label to be processed into the prompt information generation network to obtain class prompt information corresponding to the class label to be processed that is output by the prompt information generation network.

The aforementioned “at least one class label to be processed” is the result of aggregation and deduplication for the aforementioned “class label corresponding to the at least one first image”, so that the “at least one class label to be processed” can represent all the class labels involved in the “class label corresponding to the at least one first image”, and thus the “at least one class label to be processed” can represent all the classes involved in the aforementioned training dataset. A c^{th} class label to be processed is the class label of the c^{th} class present in the training dataset, so that the c^{th} class label to be processed can be used to uniquely identify the c^{th} class, wherein c is a positive integer, c≤C, C denoting the number of class labels in the “at least one class label to be processed”.

The class prompt information corresponding to the c^{th} class label to be processed is used to represent the class information carried in the c^{th} class label to be processed, wherein c is a positive integer, c≤C.

In addition, the aforementioned “class prompt information corresponding to the c^{th} class label to be processed” is not limited by the present application. For example, when the aforementioned “c^{th} class label to be processed” is the string “class.” and the aforementioned prompt information generation network is implemented using the working principle shown in the aforementioned Equation (1), the “class prompt information corresponding to the c^{th} class label to be processed” can be P_{class}={0, 0, 0, . . . , class (, . . . , 0, 0, 0}, which is adaptive task prompt information, wherein c is a positive integer, c≤C.

Step 23: Input the aforementioned task prompt information into the preset text encoder to obtain a task embedding feature output by the preset text encoder.

The task embedding feature is the result of encoding for the task identifier of the aforementioned image to be processed. Furthermore, the task embedding feature is not limited by the present application. For example, when the task prompt information corresponding to the image to be processed is Pₜₐₛₖ, and the aforementioned preset text encoder has the encoding function shown in the aforementioned Equation (2), the task embedding feature corresponding to the image to be processed may specifically be Eₜₐₛₖ=ψ(Pₜₐₛₖ).

Step 24: Input the class prompt information corresponding to the class label to be processed into the preset text encoder to obtain a class embedding feature corresponding to the class label to be processed that is output by the preset text encoder.

The class embedding feature corresponding to the c^{th} class label to be processed is the result of encoding for the c^{th} class label to be processed. Furthermore, the class embedding feature is not limited by the present application. For example, when the class prompt information corresponding to the c^{th} class label to be processed is P_{class}_{_{c}}, and the aforementioned preset text encoder has the encoding function shown in the aforementioned Equation (2), the class embedding feature corresponding to the c^{th} class label to be processed may specifically be E_{class}=(P_{class}_{_{c}}), wherein c is a positive integer, c≤C.

Step 25: Concatenate the class embedding feature corresponding to the class label to be processed with the aforementioned task embedding feature to obtain a concatenated result corresponding to the class label to be processed.

The concatenated result corresponding to the c^{th} class label to be processed is obtained by concatenating the class embedding feature corresponding to the c^{th} class label to be processed with the task embedding feature corresponding to the aforementioned image to be processed. Furthermore, the implementation of the process of determining the “concatenated result corresponding to the c^{th} class label to be processed” is not limited by the present application, and may be implemented, for example, by using the following Equation (3), wherein c is a positive integer, c≤C.

$${F}_{{class}_{c}} = Cat ( {E}_{c l a s {s}_{c}} , {E}_{task} ) \qquad ( 3 )$$

In the formula, F_{class}_{_{c}} denotes the concatenated result corresponding to the aforementioned c^{th} class label to be processed. Furthermore, the F_{class}_{_{c}}∈R^{1×D}, D denotes the feature dimension in the F_{class}_{_{c}}, and the D is the sum value between the feature dimension of E_{class}, and the feature dimension of the Eₜₐₛₖ; E_{class}_{_{c}} denotes the class embedding feature corresponding to the c^{th} class label to be processed; Eₜₐₛₖ denotes the task embedding feature corresponding to the aforementioned image to be processed; and Cat (E_{class}_{_{c}}, Eₜₐₛₖ) denotes the concatenation of the Eₜₐₛₖ after the E_{class}, (the feature concatenation approach as shown in FIG. 2).

Step 26: Determine the text embedding feature corresponding to the image to be processed based on the concatenated result corresponding to the aforementioned at least one class label to be processed.

In the present application, after the concatenated results corresponding to the class labels to be processed are obtained, these concatenated results may be aggregated (as shown in Equation (4) below) to obtain the text embedding feature corresponding to the image to be processed, so that the text embedding feature can better represent the task information and the class information corresponding to the image to be processed.

$${F}_{t} = \{ \begin{matrix}\begin{matrix}{F}_{{class}_{1}} \\ ⋮\end{matrix} \\ {F}_{{class}_{C}}\end{matrix} \} \qquad ( 4 )$$

In the formula, Fₜ denotes the text embedding feature corresponding to the aforementioned image to be processed, and the Fₜ∈R^{C×D}, C denoting the number of classes involved in the aforementioned training dataset; and F_{class} denotes the concatenated result corresponding to the aforementioned c^{th} class label to be processed, wherein c is a positive integer, c≤C.

Based on the content related to the aforementioned steps 21 to 26, it can be seen that, for the current round of training process, if the image to be processed in the aforementioned training dataset is used during that current round of training process, the text embedding feature (e.g., the text embedding feature shown in FIG. 2) corresponding to the image to be processed can be determined using the task identifier of the image to be processed, the class labels of all the classes involved in the training dataset, and the aforementioned text feature extraction module, so that the text embedding feature can relatively well represent the task information and the class information involved in the image to be processed. Thus, the objective of performing decoding for the aforementioned image to be processed can be achieved using the task information and the class information corresponding to the image to be processed based on the text embedding feature, thereby contributing to improving the decoding effect.

The aforementioned “semantic and contextual interaction” is used to aggregate the aforementioned “text embedding feature corresponding to the image to be processed” into the aforementioned feature to be processed, so as to improve the feature matching and alignment under different segmentation tasks, thereby contributing to improving the model construction effect of the image segmentation model that is suitable for multiple tasks.

In addition, the implementation of the aforementioned “semantic and contextual interaction” is not limited by the present application, and may be implemented using, for example, a pre-constructed cross-attention module, so that the “semantic and contextual interaction” can simulate the correlation between the text embedding and the multi-scale visual features with the aid of the cross-attention module. It can be seen that in a possible implementation, when the “semantic and contextual interaction” is implemented using the cross-attention module, the aforementioned step 13 may specifically be: performing semantic and contextual interaction on the aforementioned feature to be processed and the text embedding feature corresponding to the aforementioned image to be processed using the cross-attention module to obtain the first visual feature of the image to be processed.

It should be noted that the implementation of the aforementioned “cross-attention module” is not limited by the present application, and may be implemented, for example, by adopting the working principles shown in Equations (5) to (7) below.

$$Attn ( {Q}^{z} , K , V ) = softmax ( \frac{{Q}^{z} {K}^{T}}{\sqrt{{d}_{k}}} ) {V}^{T} \qquad ( 5 )$$

$${Q}^{z} = {∅}_{q} ( {F}_{v}^{z} ) , K = {∅}_{k} ( {F}_{t} ) , V = {∅}_{v} ( {F}_{t} ) \qquad ( 6 )$$

$$= H ( Attn ( {∅}_{q} ( {F}_{v}^{z} ) , {∅}_{k} ( {F}_{t} ) , {∅}_{v} ( {F}_{t} ) ) ) \qquad ( 7 )$$

In the formula, [symbol] denotes the processing result of visual enhancement for the visual feature F_{c}^{z}; Fᵥ^{z} denotes the visual feature output by a z^{th} network layer in the aforementioned first decoding module; Fₜ denotes the text embedding feature corresponding to the aforementioned image to be processed; Q^{z}, K, V denote the query, key, and value embeddings, respectively, generated by the projection layers Ø_{q}, Øₖ, and Øᵥ in the aforementioned cross-attention module; \sqrt{dₖ} denotes the scaling factor; Attn (Q^{z}, K, V) denotes the attention relationship between the visual feature Fᵥ^{z} and the text embedding feature Fₜ; and H ( ) denotes the function used in the output projection layer so that the H (Attn (Øg(Fᵥ^{z}), Øₖ (Fₜ), Øᵥ (Fₜ))) can be used to represent the processing process that uses the attention relationship to enhance visual features, wherein z is a positive integer, z≤Z, and Z is a positive integer and Z denotes the number of network layers present in the first decoding module.

The aforementioned “first visual feature of the image to be processed” is used to represent the visual information predicted to be carried in the image to be processed. For example, the “first visual feature of the image to be processed” may be the result of semantic and contextual interaction (e.g., the visual feature that is output by the decoding network in FIG. 2) between the aforementioned feature to be processed and the text embedding feature corresponding to the aforementioned image to be processed, so that the “first visual feature of the image to be processed” can represent the correlation between the text embedding feature and the multi-scale visual feature, and thus the “first visual feature of the image to be processed” can better represent the visual information carried in the image to be processed.

Based on the content related to the aforementioned step 13, it can be seen that, for the mask extractor, when the mask extractor includes an encoding network and a decoding network and the decoding network includes a first decoding module, a second decoding module, and a prediction module, after the visual features output by the network layers in the first decoding module are obtained, the visual features are cross-attention processed with the text embedding feature corresponding to the aforementioned image to be processed to obtain the enhanced visual features corresponding to the visual features, so that these enhanced visual features can better emphasize the visual features related to the given text. Thus, the first visual features of the aforementioned image to be processed can be subsequently determined based on these enhanced visual features, thereby enabling the first visual features to better represent the visual information carried in the image to be processed.

Step 14: Determine the first mask extraction result of the image to be processed based on the first visual feature of the aforementioned image to be processed, the aforementioned second decoding module, and the aforementioned prediction module.

The first mask extraction result is used to represent a mask region predicted for the aforementioned image to be processed. For example, the first mask extraction result may be multiple binary mask maps output by the mask extractor in FIG. 2. It should be noted that, for the multiple binary mask maps shown in FIG. 2, each binary mask map may be used to represent a mask region.

In addition, the implementation of the aforementioned “first mask extraction result” is not limited by the present application. For example, it may include at least one mask representation map (e.g., the binary mask map shown in FIG. 2) so that different mask representation maps can represent different mask regions predicted for the aforementioned image to be processed.

In addition, the implementation of the aforementioned step 14 is not limited by the present application. For example, when the aforementioned “first visual feature of the image to be processed” includes the result of visual enhancement for the output data of the network layers in the aforementioned first decoding module, and the first decoding module includes Z network layers arranged in sequence, the step 14 may specifically be: inputting the result of visual enhancement (e.g., [symbol] ) for the output data of the first network layer, the result of visual enhancement (e.g., [symbol] ) for the output data of the second network layer, . . . , and the result of visual enhancement (e.g., [symbol] ) for the output data of a (Z-1)^{th} network layer all to the aforementioned second decoding module to obtain the decoding result output by the second decoding module; and the result of decoding and the result of visual enhancement (e.g., [symbol] ) for the output data of a Z^{th} network layer are then subjected to multiplication by the aforementioned prediction module to obtain a first mask extraction result for the image to be processed, so that the first mask extraction result can represent a mask region predicted for the image to be processed.

Based on the content related to the aforementioned steps 11 to 14, it can be seen that, in a possible implementation, the aforementioned mask extractor may be implemented using the mask extractor shown in FIG. 2 so that the mask extractor can implement a mask extraction process for a piece of image data based on the working principle shown in the aforementioned steps 11 to 14. Since the decoding process related to the mask extractor is implemented with reference to the text embedding feature corresponding to the image data and the text embedding feature is determined based on the task identifier corresponding to the image data as well as the relevant class label, reference is made to the task information and the class information corresponding to the image data during the decoding process, so that the mask extraction result output by the decoding process can be used to better represent the mask region predicted for the image data. This contributes to improving the effect of mask extraction presented by the mask extractor under different segmentation tasks.

Based on the content related to the aforementioned S102, it can be seen that, for the current round of training process, after the image to be processed is obtained, the image to be processed can be input into the mask extractor, so as to make the mask extractor perform mask extraction for the image to be processed to obtain a first visual feature and a first mask extraction result of the image to be processed, so that the first visual feature can represent the visual information predicted to be carried in the image to be processed (e.g., which objects are carried), and the first mask extraction result can represent the predicted position, in the image to be processed, of each object (e.g., an object such as a sheep) in the image to be processed. Thus, the prediction performance achieved by the mask extractor can be subsequently measured with the help of the first visual feature and the first mask extraction result.

S103: Determine a mask prediction loss based on the first mask extraction result and a mask label corresponding to the image to be processed.

The aforementioned “mask label corresponding to the image to be processed” is used to represent the a priori information of the mask region corresponding to the image to be processed in the current round of training process. Furthermore, the “mask label corresponding to the image to be processed” is determined based on the task identifier of the image to be processed. For ease of understanding, an illustration is given below in combination with an example.

As an example, when the model construction method according to the present application is used to construct an image segmentation model that is suitable for use in several image segmentation tasks, the process of determining the aforementioned “mask label corresponding to the image to be processed” may specifically include the following steps 31 to 32.

Step 31: Determine the task identifier of the aforementioned image to be processed from task identifiers of the aforementioned several image segmentation tasks, so that the “task identifier of the image to be processed” can represent the image segmentation task corresponding to the image to be processed.

It should be noted that, for the content related to step 31, reference can be made to the content related to the aforementioned “task identifier of the image to be processed”. For example, the step 31 may specifically be: selecting one identifier at random from the task identifiers of the aforementioned several image segmentation tasks and determining it to be the task identifier of the image to be processed.

It should also be noted that the aforementioned “several image segmentation tasks” may be set in advance based on the application scenario, which may specifically include, for example: an image semantic segmentation task, an image instance segmentation task, and an image panoptic segmentation task.

It should be noted that, for each round of training process, if the training process involves more than one image to be processed, in order to better improve the effect of model training, the same task identifier can be selected for all images to be processed for supervision. This can ensure that the model update is performed based on the supervision information under the same image segmentation task in each round of training process, thereby effectively avoiding the defects of task conflicts due to the difference in task identifiers corresponding to these images to be processed, which in turn is conducive to improving the effect of model training.

Based on the content in the preceding paragraph, it can be seen that, in a possible implementation, when the number of the aforementioned images to be processed is a plurality (i.e., multiple pieces of image data are used in each round of training process), the aforementioned step 31 may specifically be: selecting one task identifier at random from the task identifiers of the aforementioned several image segmentation tasks, and selecting the obtained task identifier to be determined as the task identifier of each image to be processed, so as to ensure that all the image data have the same task identifier in the same round of training process, and thus to ensure that the model optimization is performed based on the supervision information of only one image segmentation task in each round of training process.

Step 32: Look up a mask label corresponding to the task identifier of the aforementioned image to be processed from a pre-constructed second mapping relationship, and determine it as the mask label corresponding to the image to be processed.

The second mapping relationship is used to record the mask labels corresponding to the aforementioned image to be processed under the image segmentation tasks. For example, when the aforementioned “several image segmentation tasks” include an image semantic segmentation task, an image instance segmentation task, and an image panoptic segmentation task, and the image to be processed is image data I^{gt}, the second mapping relationship may include a correspondence between a task identifier Task^{sem} of the image semantic segmentation task and a mask label

$${M}_{sem}^{gt}$$

corresponding to the image to be processed under the image semantic segmentation task, a correspondence between a task identifier Task^{ins} of the image instance segmentation task and a mask label

$${M}_{ins}^{gt}$$

corresponding to the image to be processed under the image instance segmentation task, and a correspondence between a task identifier Task^{pan} of the image panoptic segmentation task and a mask label

$${M}_{pan}^{gt}$$

corresponding to the image to be processed under the image panoptic segmentation task.

It should be noted that the manner of obtaining the aforementioned “mask labels corresponding to the image to be processed under the image segmentation tasks” in the preceding paragraph is not limited by the present application, and may be determined, for example, by means of manual labeling.

Based on the content related to the aforementioned steps 31 to 32, it can be seen that, for the current round of training process, after the image to be processed is obtained, the task identifier of the aforementioned image to be processed can be determined from task identifiers of the several image segmentation tasks, so that the “task identifier of the image to be processed” can represent the image segmentation task corresponding to the image to be processed; and then, the mask label corresponding to the image to be processed is looked up from the pre-constructed second mapping relationship based on the “task identifier of the image to be processed”, so that the mask label can represent the actual mask region that the image to be processed has under the “image segmentation task corresponding to the image to be processed”. Thus, the mask label can subsequently be used as the a priori information to guide the mask extraction for the image to be processed.

The aforementioned “mask prediction loss” is used to represent the performance achieved by the mask extractor in terms of mask prediction during the current round of training process. Furthermore, the process of determining the mask prediction loss is not limited by the present application, and may be implemented, for example, using Equation (8) below.

$${L}_{mask} = {L}_{F} ( {M}_{gt}^{pre} , {M}_{gt}^{act} ) + {L}_{D} ( {M}_{gt}^{pre} , {M}_{gt}^{act} ) \qquad ( 8 )$$

In the formula, Lₘₐₛₖ denotes the aforementioned “mask prediction loss”;

$${M}_{gt}^{pre}$$

denotes we first mask extraction result of the aforementioned image to be processed I^{gt}; and I^{gt} denotes the image to be processed;

$${M}_{gt}^{act}$$

denotes the mask label corresponding to the image to be processed I^{gt}, so that the

$${M}_{gt}^{act}$$

can denote the actual mask region that the image to be processed has under the aforementioned “image segmentation task corresponding to the image to be processed”, and if the aforementioned “several image segmentation tasks” include an image semantic segmentation task, an image instance segmentation task, and an image panoptic segmentation task, then the

$${M}_{gt}^{act} ∈ ( {M}_{sem}^{gt} , {M}_{ins}^{gt} , {M}_{pan}^{gt} ) ,$$

wherein the

$${M}_{sem}^{gt}$$

denotes the mask label corresponding to the image to be processed under the image semantic segmentation task, the

$${M}_{ins}^{gt}$$

denotes the mask label corresponding to the image to be processed under the image instance segmentation task, and the

$${M}_{pan}^{gt}$$

denotes the mask label corresponding to the image to be processed under the image panoptic segmentation task; L_{F} ( ) denotes the function of calculating the Focal loss; and L_{D} ( ) denotes the function of calculating the Dice loss. It should be noted that the implementations of the L_{F} ( ) and the L_{D} ( ) are not limited by the present application.

Based on the content related to the aforementioned S103, it can be seen that, for the current round of training process, after the mask extractor is used to output the first mask extraction result (e.g., multiple binary mask maps output by the mask extractor in FIG. 2) for the aforementioned image to be processed, a mask prediction loss (e.g., the mask prediction loss shown in FIG. 2) corresponding to the mask extractor is determined based on the first mask extraction result as well as the mask label corresponding to the image to be processed, so that the mask prediction loss can indicate the performance achieved by the mask extractor in terms of mask prediction during the current round of training process.

S104: Determine a class prediction loss based on a similarity matching map between the first visual feature and a text embedding feature corresponding to the image to be processed, and a class label corresponding to the image to be processed, wherein the text embedding feature is determined based on a task identifier of the image to be processed and a class label corresponding to the at least one first image.

The aforementioned “similarity matching map between the first visual feature and the text embedding feature corresponding to the image to be processed” is the result of calculation of the similarity between the aforementioned “first visual feature of the image to be processed” and the aforementioned “text embedding feature corresponding to the image to be processed”, so that the similarity matching map can represent the class belonging situation of the mask region predicted for the image to be processed.

In addition, the calculation process for the aforementioned similarity matching map is not limited by the present application, and may be implemented, for example, with the help of the cosine similarity shown in Equation (9) below.

$${S}_{i , j} = cos ( {F}_{v}^{i} , {F}_{t}^{j} ) = \frac{{F}_{v}^{i} * {F}_{t}^{j}}{‖ {F}_{v}^{i} ‖ \times ‖ {F}_{t}^{j} ‖} \qquad ( 9 )$$

In the formula, S_{i,j} is the element in an i^{th} row and a j^{th} column of the aforementioned “similarity matching map between the first visual feature and the text embedding feature corresponding to the image to be processed”, so that the S_{i,j} can indicate the likelihood that the i^{th} predicted region predicted for the image to be processed belongs to the j^{th} class involved in the aforementioned training dataset (i.e., the class represented by the j^{th} class label to be processed); Fᵥ denotes the aforementioned “first visual feature of the image to be processed”, and Fᵥ∈R^{N×D}, wherein N denotes the number of rows in the Fᵥ, so that the N can denote the number of predicted regions that are predicted for the image to be processed; Fᵥⁱdenotes the i^{th} row of features in the F_{y}, so that the Fᵥⁱ can represent the visual information carried in the i^{th} predicted region predicted for the image to be processed, i∈[1, N]; Fₜ denotes the text embedding feature corresponding to the aforementioned image to be processed, and the Fₜ ∈ R^{C×D}, C denoting the number of classes involved in the training dataset; Fₜ denotes the j^{th} row of features in the Fₜ, so that the Fₜ′ can represent the j^{th} class label to be processed involved in the aforementioned training dataset; and F_{y}*Fₜ′ denotes the dot product between the F_{y}′ and the Fₜ′.

The aforementioned “class label corresponding to the image to be processed” is used to represent the actual class corresponding to each of the actual mask regions in the image to be processed. Furthermore, the “class label corresponding to the image to be processed” is not limited by the present application, and may be determined, for example, based on the manual labeling approach. For another example, in some application scenarios, the obtaining process for the “class label corresponding to the image to be processed” is similar to the obtaining process for the aforementioned “mask label corresponding to the image to be processed”, and will not be repeated here for the sake of brevity.

The aforementioned “class prediction loss” is used to represent the performance achieved by the mask extractor in terms of class prediction during the current round of training process.

In addition, the implementation of the aforementioned S104 is not limited by the present application, and may specifically be, for example: determining a cross-entropy loss Lcla between the aforementioned “similarity matching map between the first visual feature and the text embedding feature corresponding to the image to be processed” and the aforementioned “class label corresponding to the image to be processed” to be the aforementioned class prediction loss.

Based on the content related to the aforementioned S104, it can be seen that, for the current round of training process, after the mask extractor is used to output the first visual feature (e.g., the visual feature output by the decoding network in FIG. 2) for the aforementioned image to be processed, the similarity matching map between the first visual feature and the text embedding feature corresponding to the image to be processed is first calculated, so that the similarity matching map can represent the probabilities of the predicted classes of all the predicted mask regions; the similarity matching map is then used to calculate the cross-entropy loss that is obtained from the supervision performed by the class label corresponding to the image to be processed as the class prediction loss corresponding to the mask extractor (e.g., the class prediction loss shown in FIG. 2), so that the class prediction loss can represent the performance achieved by the mask extractor in terms of class prediction during the current round of training process.

S105: Determine whether a first stopping condition is met, and if yes, perform S107 below; if no, perform S106 below.

The first stopping condition is the training stopping condition set in advance for the aforementioned mask extractor. Furthermore, the first stopping condition is not limited by the present application, and may be, for example, that the model loss of the mask extractor is below a first loss threshold that is set in advance. For another example, it may also be that the change rate of the model loss of the mask extractor is below a first change rate threshold that is set in advance. As a further example, it may also be that the training iteration process for the mask extractor reaches a first number of iterations that is set in advance.

The aforementioned “model loss of the mask extractor” is used to represent the prediction performance of the mask extractor during the current round of training process. Furthermore, the “model loss of the mask extractor” is not limited by the present application, and may be implemented, for example, using Equation (10) below.

$${L}_{model} = {L}_{cla} + {L}_{mask} \qquad ( 10 )$$

In the formula, Lmodel denotes the model loss of the aforementioned mask extractor; Lcla denotes the class prediction loss corresponding to the mask extractor; and Lₘₐₛₖ denotes the mask prediction loss corresponding to the mask extractor.

It should be note that the execution time of the aforementioned S105 is not limited by the present application, for example, as long as it is ensured that the execution time of the S105 is later than the execution time of the aforementioned S102.

Based on the content related to the aforementioned S105, it can be seen that, for the current round of training process, after the mask extractor is used to output some prediction results (e.g., the aforementioned first visual feature and first mask extraction result) for the image to be processed, the model loss of the mask extractor can be determined based on these prediction results, so that the model loss can represent the prediction performance that the mask extractor has during the current round of training process. Thus, it can be determined subsequently based on the model loss whether a first stopping condition is met, and if it is determined that the first stopping condition is met, it can be determined that the mask extractor has a relatively good mask extraction performance for multiple image segmentation tasks, and therefore S107 below can be directly executed; if it is determined that the first stopping condition is not met, it can be determined that the mask extraction performance presented by the mask extractor for the multiple image segmentation tasks still needs further improvement, and therefore S106 below can be directly executed.

S106: If the first stopping condition is not met, update the mask extractor based on the mask prediction loss and the class prediction loss, and continue to execute the aforementioned S101 and its subsequent steps.

In the present application, for the current round of training process, if it is determined that the first stopping condition is not met, it can be determined that the mask extraction performance presented by the mask extractor for the multiple image segmentation tasks still needs further improvement, and therefore the model loss of the mask extractor can be first determined based on the aforementioned mask prediction loss and the aforementioned class prediction loss; the mask extractor is then updated based on the model loss to obtain an updated mask extractor to enable the updated mask extractor to have a better mask extraction function, so that the aforementioned S101 and its subsequent steps can be subsequently executed based on the updated mask extractor to start the next round of training process for the mask extractor.

It should be noted that the implementation of the step of “updating the mask extractor based on the model loss” in the preceding paragraph is not limited by the present application, and may be implemented using, for example, any existing or future model update method (e.g., a gradient back propagation method).

S107: Determine an image segmentation model based on the mask extractor if the a first stopping condition is met.

In the present application, for the current round of training process, if it is determined that the first stopping condition is met, it can be determined that the mask extractor has a relatively good mask extraction performance for the multiple image segmentation tasks, and therefore the image segmentation model can be determined based on the mask extractor, so as to make the image segmentation model include the mask extractor used in the final round of training process, so that the image segmentation model has a relatively good mask extraction effect for all the multiple image segmentation tasks, thereby contributing to improving the effect of image segmentation of the image segmentation model under the multiple image segmentation tasks.

In addition, the implementation of the aforementioned step of “determining an image segmentation model based on the mask extractor” is not limited by the present application. For example, when the “text embedding feature corresponding to the image to be processed” is determined based on the aforementioned “text feature extraction module”, it may specifically be: determining the image segmentation model based on the mask extractor and the text feature extraction module to cause the image segmentation model to include the mask extractor and the text feature extraction module, so that the decoding network in the mask extractor can perform decoding with reference to the text embedding feature output by the text feature extraction module. Thus, the mask extractor makes reference to the task information and the class information in the decoding process, so that a set of binary masks with text guidance that are generated by the mask extractor can better represent a mask extraction result for a piece of image data, thereby facilitating the improvement of the effect of mask extraction.

Based on the content related to the aforementioned S101 to S107, it can be seen that, for the model construction method according to an embodiment of the present application, the method includes: training a mask extractor using a training dataset and mask labels that the training dataset has in several image segmentation tasks, so that the trained mask extractor has a good effect of mask extraction under all these image segmentation tasks. Thus, an image segmentation model constructed using the trained mask extractor has a good effect of image segmentation under all these image segmentation tasks, which in turn makes the image segmentation model suitable for image segmentation for image data under these image segmentation tasks. This makes the image segmentation model have a multi-image segmentation task processing function, so that the objective of completing multiple image segmentation tasks using one model can be achieved, so that the image segmentation model can be subsequently used to perform image segmentation for image data under multiple image segmentation tasks. This can effectively improve the generalization performance of the image segmentation model, and thus can effectively improve the effect of image segmentation of the image segmentation model.

In fact, in order to better improve the text representation performance of a text embedding feature of a piece of text information, the present application further provides a possible implementation of the aforementioned model construction method. In the implementation, when the aforementioned “text embedding feature corresponding to the image to be processed” is determined based on the aforementioned “text feature extraction module” and the “text feature extraction module” includes a prompt information generation network and a preset text encoder, the model construction method may include, in addition to the aforementioned S101 to S107, steps 41 to 47 below. The execution time for step 41 is later than the execution time for the aforementioned S107.

Step 41: Determine an image to be used from a test dataset, the test dataset including at least one second image that includes the image to be used.

The test dataset is an image dataset that needs to be used in the testing process. Furthermore, the test dataset is not limited by the present application, and may be implemented using, for example, any existing or future test dataset that can participate in the testing process for the image segmentation model.

In fact, for the aforementioned test dataset, the test dataset may at least include at least one second image so that the model testing process can subsequently be completed with the aid of these second images. The second image is the image data that needs to be used in the testing process.

In addition, the association relationship between the aforementioned “at least one second image” and the aforementioned “at least one first image” is not limited by the present application. For example, there is a partial overlap (or even no overlap) between the class to which the “at least one second image” relates and the class to which the “at least one first image” relates. That is, among the class labels corresponding to the at least one second image, there are some classes that do not appear in the aforementioned “class label corresponding to the at least one first image”.

The image to be used is the image data that needs to be used in the current round of testing process. Furthermore, the image to be used is not limited by the present application, and may be, for example, any one of the second images recorded in the aforementioned test dataset.

In addition, the implementation of the aforementioned step 41 is not limited by the present application, and may be implemented using, for example, any existing or future implementation method for obtaining image data that can be employed during each round of testing process.

Step 42: Determine, using the image segmentation model, a second mask extraction result of the aforementioned image to be used and a text embedding feature corresponding to the image to be used.

The aforementioned “second mask extraction result of the image to be used” is used to represent the mask region predicted for the image to be used. Furthermore, the content related to the “second mask extraction result of the image to be used” is similar to the content related to the aforementioned “first mask extraction result of the image to be processed”, and will not be repeated here for the sake of brevity.

As can be seen, in some possible implementations, the aforementioned “second mask extraction result of the image to be used” may include region representation results of several mask regions. The region representation result of a y^{th} mask region is used to represent the y^{th} mask region predicted for the image to be used. Furthermore, the implementation of the “region representation result of the y^{th} mask region” is not limited by the present application, and may be implemented, for example, by using the binary mask map shown in FIG. 2. y is a positive integer, y≤Y, and Y is a positive integer and Y denotes the number of mask regions in the “several mask regions”.

The aforementioned “text embedding feature corresponding to the image to be used” is used to describe the task information and the class information corresponding to the image to be used. Furthermore, the process of determining the “text embedding feature corresponding to the image to be used” may include: determining the text embedding feature corresponding to the image to be used based on the text feature extraction module in the aforementioned image segmentation model, the task identifier of the image to be used, and the class label corresponding to the aforementioned at least one second image. The “task identifier of the image to be used” is used to uniquely identify the image segmentation task corresponding to the image to be used. Furthermore, the content related to the “task identifier of the image to be used” is similar to the content related to the aforementioned “task identifier of the image to be processed”, and will not be repeated here for the sake of brevity. The “class label corresponding to the second image” is class a priori information pre-determined for the second image. Furthermore, the content related to the “class label corresponding to the second image” is similar to the content related to the aforementioned “class label corresponding to the first image”, and will not be repeated here for the sake of brevity.

It should be noted that the process of determining the aforementioned “text embedding feature corresponding to the image to be used” is similar to the process of determining the aforementioned “text embedding feature corresponding to the image to be processed”, and will not be repeated here for the sake of brevity.

Based on the content related to the aforementioned step 42, it can be seen that, for the current round of testing process, after the image to be used is obtained from the test dataset, the mask extractor in the image segmentation model may be used to determine the second mask extraction result of the image to be used, and the text feature extraction module in the image segmentation model may be used to determine the text embedding feature corresponding to the image to be used, so that the text representation performance of the text feature extraction module in the image segmentation model can be subsequently measured based on the two pieces of information.

Step 43: Determine a second visual feature of the image to be used based on the aforementioned image to be used, the second mask extraction result corresponding to the image to be used, and a preset visual encoder.

The preset visual encoder is a virtual encoder that is set in advance. Furthermore, the preset visual encoder is not limited by the present application, and may be, for example, a pre-trained CLIP visual encoder, as shown in FIG. 2.

The aforementioned “second visual feature of the image to be used” is used to represent the visual information carried in each of the mask regions predicted for the image to be used.

In addition, the process of determining the aforementioned “second visual feature of the image to be used” (i.e., the implementation of the aforementioned step 43) is not limited by the present application. For example, when the aforementioned “second mask extraction result corresponding to the image to be used” includes the region representation results (e.g., the multiple binary mask maps output by the mask extractor in FIG. 2) of the several mask regions, the step 43 may specifically include steps 431 and 432 below.

Step 431: Extract a mask region image corresponding to each mask region from the aforementioned image to be used based on a region representation result of the mask region.

The mask region image corresponding to the y^{th} mask region is used to represent the visual information carried in the y^{th} mask region. Furthermore, the process of determining the “mask region image corresponding to the y^{th} mask region” is not limited by the present application, and may specifically be, for example: extracting a mask region image corresponding to the y^{th} mask region from the aforementioned image to be used based on a region representation result corresponding to the y^{th} mask region, so that the “mask region image corresponding to the y^{th} mask region” can represent the visual information carried in the y^{th} mask region. y is a positive integer, y≤Y.

It should be noted that the implementation of the aforementioned step 431 is not limited by the present application, and may be implemented using, for example, any existing or future method for performing image extraction (e.g., the extraction method shown in FIG. 2) based on a mask result.

Step 432: Input mask region images corresponding to the several mask regions into the preset visual encoder to obtain the second visual feature output by the preset visual encoder.

In the present application, for the current round of testing process, after the mask region images corresponding to the several mask regions are obtained, these mask region images are input to the preset visual encoder, so as to cause the preset visual encoder to perform mask-level visual encoding for these mask region images to obtain a second visual feature of the aforementioned image to be used, so that the second visual feature can represent the visual information carried in each of the mask regions.

Based on the content related to the aforementioned step 43, it can be seen that, in a possible implementation, for the current round of testing process, after a set of binary masks with text guidance are determined for the aforementioned image to be used using the mask extractor in the image segmentation model, a pre-trained CLIP visual encoder may be used to perform mask-level visual encoding for these binary masks to obtain the second visual feature corresponding to the image to be used, so that the second visual feature can represent the mask-level visual concept. Thus, the text representation performance of the text feature extraction module in the image segmentation model can be subsequently measured based on the second visual feature.

Step 44: Determine an entropy loss based on a similarity matching map between the second visual feature of the aforementioned image to be used and the text embedding feature corresponding to the image to be used, and at least one new class label, wherein the at least one new class label is determined based on a result of a comparison between the class label corresponding to the aforementioned at least one first image and a class label corresponding to the aforementioned at least one second image.

The aforementioned “similarity matching map between the second visual feature of the image to be used and the text embedding feature corresponding to the image to be used” is the result obtained from similarity calculation for the aforementioned “second visual feature of the image to be used” and the aforementioned “text embedding feature corresponding to the image to be used”, so that the similarity matching map can represent the class belonging situation of the mask region predicted for the image to be used.

In addition, the content related to the aforementioned “similarity matching map between the second visual feature of the image to be used and the text embedding feature corresponding to the image to be used” is similar to the content related to the aforementioned “similarity matching map between the first visual feature and the text embedding feature corresponding to the image to be processed”, and will not be repeated here for the sake of brevity.

The aforementioned “at least one new class label” is a class label that is present in the aforementioned “class label corresponding to the at least one second image” but not in the aforementioned “class label corresponding to the at least one first image”, so that the “at least one new class label” can represent a newly added class in the test dataset.

In addition, the process of determining the aforementioned “at least one new class label” is not limited by the present application, and may specifically be, for example: first, comparing the class label corresponding to the aforementioned at least one first image with the class label corresponding to the aforementioned at least one second image to obtain a comparison result, so that the comparison result can indicate a difference between the classes involved in the aforementioned training dataset and the classes involved in the aforementioned test dataset; then, determining the at least one new class label based on the comparison result, so that these new class labels can represent the newly added classes in the test dataset compared to the aforementioned training dataset.

The above “entropy loss” is used to represent the prediction performance achieved by the aforementioned image segmentation model in terms of classification, so that the “entropy loss” can represent the text representation performance achieved by the prompt information generation network in the image segmentation model.

In addition, the process of determining the aforementioned “entropy loss” (i.e., the implementation of the aforementioned step 44) is not limited by the present application. For example, when the aforementioned “second mask extraction result corresponding to the image to be used” includes the region representation results of the several mask regions (e.g., the multiple binary mask maps output by the mask extractor in FIG. 2), the step 44 may specifically include steps 441 to 444 below.

Step 441: Obtain through filtering a similarity value corresponding to each new class label from the aforementioned “similarity matching map between the second visual feature of the image to be used and the text embedding feature corresponding to the image to be used” to obtain a similarity set corresponding to each mask region, wherein the similarity set is used to record a similarity value corresponding to the mask region of each new class label.

As an example, when the y^{th} row in the aforementioned “similarity matching map between the second visual feature of the image to be used and the text embedding feature corresponding to the image to be used” indicates the class belonging situation of the aforementioned y^{th} mask region, the step 441 may specifically be: obtaining through filtering a similarity value corresponding to each new class label from the y^{th} row to obtain a similarity set corresponding to the y^{th} mask region, so as to make the similarity set include the filtered similarity values corresponding to the new class labels, so that the similarity set can indicate the class belonging probabilities of the y^{th} mask region under the new class labels. y is a positive integer, y≤Y.

Step 442: Determine an entropy value corresponding to each mask region based on the similarity set corresponding to the mask region.

The entropy value corresponding to the y^{th} mask region is used to indicate the confidence level of the similarity set corresponding to the y^{th} mask region. Furthermore, the process of determining the “entropy value corresponding to the y^{th} mask region” is not limited by the present application, and may be implemented using, for example, Equation (11) below. y is a positive integer, y≤Y.

$${entro}_{y} = - \frac{1}{{N}_{u}} {\sum }_{l = 1}^{{N}_{u}} {s}_{y , l} log ( {s}_{y , l} ) \qquad ( 11 )$$

In the formula, entroy denotes the entropy value corresponding to the y^{th} mask region; Nu denotes the number of class labels in the aforementioned “at least one new class label”; and Sy, represents the intersection between the y^{th} row and the column wherein the I^{th} new class label is located in the aforementioned “similarity matching map between the second visual feature of the image to be used and the text embedding feature corresponding to the image to be used”, so that the Syl can indicate the likelihood that the y^{th} mask region belongs to the I^{th} new class label.

Step 443: Select at least one target region from the several mask regions based on entropy values corresponding to the several mask regions, wherein an entropy value corresponding to the target region satisfies a preset entropy value condition.

The target region is a mask region that has a high confidence level under the aforementioned “at least one new class label”.

The aforementioned “preset entropy value condition” is used to obtain through filtering a mask region that has a high confidence level under the aforementioned “at least one new class label”. Furthermore, the preset entropy value condition is not limited by the present application, and may specifically be, for example: the entropy value corresponding to the target region <a preset entropy value threshold (e.g., 8).

In addition, the implementation of the aforementioned step 443 is not limited by the present application, and may specifically be, for example: after the entropy value corresponding to the y^{th} mask region is obtained, it is determined whether the entropy value corresponding to the y^{th} mask region is less than the preset entropy value threshold, and if it is smaller than the preset entropy value threshold, it can be determined that the entropy value corresponding to the y^{th} mask region is relatively small, and thus it can be determined that the y^{th} mask region has a high confidence level under the aforementioned “at least one new class label”, and thus it can further be determined that the y^{th} mask region satisfies the aforementioned preset entropy value condition, and therefore the y^{th} mask region can be determined as the target region; however, if it is not less than the preset entropy value threshold, it can be determined that the entropy value corresponding to the y^{th} mask region is relatively large, and thus it can be determined that the y^{th} mask region has a low confidence level under the aforementioned “at least one new class label”, and thus it can further be determined that the y^{th} mask region does not satisfy the aforementioned preset entropy value condition, and therefore the y^{th} mask region can be directly discarded. y is a positive integer, y≤Y.

Step 444: Determine the entropy loss based on a similarity set corresponding to the aforementioned at least one target region.

It should be noted that the implementation of the aforementioned step 444 is not limited by the present application, and may be implemented using, for example, Equation (12) below.

$${L}_{ent} = - \frac{1}{{N}_{u} K} {\sum }_{l = 1}^{{N}_{u}} {\sum }_{k = 1}^{K} {s}_{kl} log ( {s}_{kl} ) \qquad ( 12 )$$

In the formula, Lₑₙₜ denotes the entropy loss; Nu denotes the number of class labels in the aforementioned “at least one new class label”; and K denotes the number of regions in the aforementioned “at least one target region”; and S_{k,l} represents the intersection between the row in which the k^{th} target region is located and the column in which the A^{th} new class label is located in the aforementioned “similarity matching map between the second visual feature of the image to be used and the text embedding feature corresponding to the image to be used”, so that the S_{k,l} can represent the likelihood that the k^{th} target region belongs to the l^{th} new class label.

Based on the content related to the aforementioned step 44, it can be seen that in the current round of testing process, after the second visual feature corresponding to the aforementioned image to be used is obtained, a similarity matching map between the second visual feature and the text embedding feature corresponding to the image to be used can be calculated first; and the similarity matching map and some newly added classes in the test dataset are then used to determine an entropy loss, so that the entropy loss can represent the text representation performance achieved by the prompt information generation network in the image segmentation model under these classes.

Step 45: Determine whether a second stopping condition is met, and if yes, execute step 47 below; if no, execute step 46 below.

The second stopping condition is an update stopping condition preset for the aforementioned prompt information generation network. Furthermore, the second stopping condition is not limited by the present application, and may be, for example, that the entropy loss corresponding to the prompt information generation network is lower than a preset second loss threshold. For another example, it may also be that the change rate of the entropy loss corresponding to the prompt information generation network is lower than a preset second change rate threshold. As a further example, it may also be that the update iteration process for the prompt information generation network reaches a preset second number of iterations. It should be noted that, for the content related to the “entropy loss corresponding to the prompt information generation network”, reference can be made to the content related to the aforementioned step 44.

It should be noted that the execution time of the aforementioned step 45 is not limited by the present application, for example, as long as it is ensured that the execution time of the step 45 is later than the execution time of the aforementioned step 42.

Based on the content related to the aforementioned step 45, it can be seen that, for the current testing process, after the image segmentation model is used to output some prediction results (e.g., the aforementioned second mask extraction result) for the image to be used, an entropy loss corresponding to the prompt information generation network in the image segmentation model can be determined based on these prediction results, so that the entropy loss can represent the text representation performance achieved by the prompt information generation network under these new classes. Thus, it can be determined subsequently based on the entropy loss whether the second stopping condition is met, and if it is determined that the second stopping condition is met, it can be determined that the prompt information generation network has a relatively good effect of text representation for multiple image segmentation tasks, and therefore step 47 below can be directly executed; if it is determined that the second stopping condition is not met, it can be determined that the text representation performance presented by the prompt information generation network for the multiple image segmentation tasks still needs further improvement, and therefore step 46 below can be executed directly.

Step 46: When it is determined that the second stopping condition is not met, update the prompt information generation network in the image segmentation model based on the aforementioned entropy loss and return to execute the aforementioned step 41 and its subsequent steps.

In the present application, for the current round of testing process, if it is determined that the second stopping condition is not met, it can be determined that the text representation performance presented by the prompt information generation network in the image segmentation model for the multiple image segmentation tasks still needs further improvement, and therefore the prompt information generation network can be first updated based on the entropy loss corresponding to the prompt information generation network to obtain an updated prompt information generation network, so that the updated prompt information generation network has a better mask extraction function. Thus, the text embedding features determined subsequently for some texts using the updated prompt information generation network can better represent those texts, so that the aforementioned step 41 and its subsequent steps can be subsequently performed based on the updated prompt information generation network to start the next round of update iteration process for the prompt information generation network.

It should be noted that the implementation of the step of “updating the prompt information generation network based on the entropy loss corresponding to the prompt information generation network” in the preceding paragraph is not limited by the present application, and may be implemented using, for example, any existing or future model update method (e.g., a gradient back propagation method).

Step 47: Save the final trained image segmentation model when it is determined that the second stopping condition is met.

In the present application, for the current round of testing process, if it is determined that the second stopping condition is met, it can be determined that the prompt information generation network has a relatively good effect of text representation for multiple image segmentation tasks, and therefore the image segmentation model used in the last round of testing process is saved, so that the image segmentation model can be used subsequently to perform image segmentation for the image data under any one of the image segmentation tasks.

Based on the content related to the aforementioned steps 41 to 47, it can be seen that, for some possible implementations, in the testing phase, adaptive prompt learning for some pieces of text information (e.g., some new classes) can be completed with the help of an update iteration process for the prompt information generation network in the aforementioned image segmentation model to achieve seamless adaptation to unseen classes for the purpose of open-vocabulary segmentation. This is conducive to improving the image segmentation performance of the image segmentation model under multiple image segmentation tasks.

Based on the content related to the aforementioned “test dataset”, it can be seen that, in some application scenarios, when there are newly added classes in the test dataset that do not exist in the aforementioned “training dataset”, the iteration process illustrated in the aforementioned steps 41 to 47 can be used to improve adaptive prompts for these newly added classes (i.e., some classes that do not exist in the aforementioned “training dataset”) to generalize the model to different classes.

Based on the content related to the aforementioned model construction method, it can be seen that the present application provides a novel open segmentation framework (e.g., the open segmentation framework shown in FIG. 2) for the objective of unified, general, and open-vocabulary segmentation.

In addition, the aforementioned open segmentation framework can achieve three objectives shown in (i) to (iii) below.

(i) Unification: The aforementioned open segmentation framework is a unified (i.e., integrated) network, so that the open segmentation framework can achieve the objective of using the same architectural and inference parameters to process multiple different image segmentation tasks (e.g., an image semantic segmentation task, an image instance segmentation task, and an image panoptic segmentation task). That is, multiple kinds of different image segmentation tasks are completed with the help of the same image segmentation model.

(ii) Generalization: The aforementioned open segmentation framework can be adapted to a variety of image segmentation tasks, for example, an image semantic segmentation task, an image instance segmentation task, and an image panoptic segmentation task.

(iii) Open-Vocabulary Segmentation: The aforementioned open segmentation framework can be generalized to any segmentation class (e.g., classes involved in the training process or classes not involved in the training process, among others).

In addition, the aforementioned open segmentation framework uses a two-phase segmentation framework in the training process and the testing process, wherein a general mask representation is extracted in the first phase and classification is performed on these masks in the second phase, so that in the subsequent training or testing process for the open segmentation framework, the result of the classification can be used to optimize a unified segmentation model with multi-task labels, which helps to capture the task characteristics of the general segmentation.

Furthermore, the aforementioned open segmentation framework also introduces an adaptive prompt learning scheme that encodes the concepts of task awareness and class sensitivity into the text abstraction in order to enable the text abstraction to better represent a text, so that the open segmentation framework can flexibly complete different segmentation tasks for any class. This can achieve the objective of using one model to handle all tasks and classes.

In addition, the aforementioned open segmentation framework also uses semantic context interaction and testing-phase prompt module adjustment mechanisms to improve cross-model consistency and generalization to unseen classes.

Based on the above eight paragraphs, it can be seen that the aforementioned open segmentation framework is a task-flexible, class-unrestricted, and high-performance unified framework in order to make the open segmentation framework present relatively good effects in terms of mask extraction, task generalization, and class generalization.

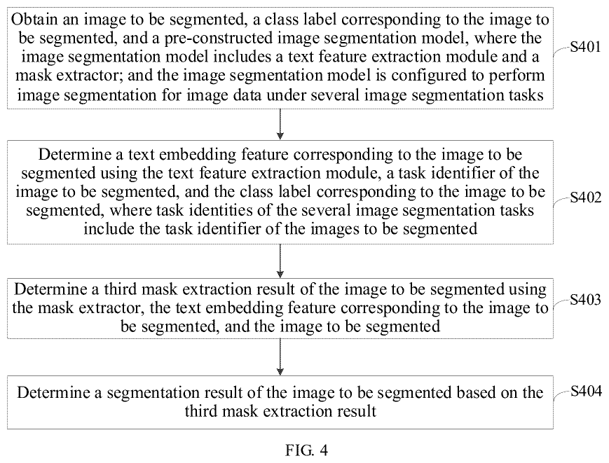

Based on the content related to the aforementioned model construction method, the present application also provides an image segmentation method, which is described below in conjunction with the accompanying drawings for ease of understanding. As shown in FIG. 4, an image segmentation method according to an embodiment of the present application includes S401 to S404 below. FIG. 4 is a flowchart of an image segmentation method according to an embodiment of the present application.

S401: Obtain an image to be segmented, a class label corresponding to the image to be segmented, and a pre-constructed image segmentation model, wherein the image segmentation model includes a text feature extraction module and a mask extractor; and the image segmentation model is configured to perform image segmentation for image data under several image segmentation tasks.

The image to be segmented is the image data that requires image segmentation (e.g., mask extraction) under a target segmentation task. It should be noted that the target segmentation task is not limited by the present application, and may be, for example, an image segmentation task specified by the user for the image to be segmented.

The aforementioned “class label corresponding to the image to be segmented” is used to indicate which class of objects are carried in the image to be segmented. Furthermore, the manner of obtaining the “class label corresponding to the image to be segmented” is not limited by the present application, and may be implemented by means of, for example, manual labeling.

For the content related to the aforementioned “image segmentation model”, reference can be made to the content related to the aforementioned “model construction method”, which will not be repeated here for the sake of brevity.

S402: Determine a text embedding feature corresponding to the image to be segmented using the text feature extraction module, a task identifier of the image to be segmented, and the class label corresponding to the image to be segmented, wherein task identifiers of the several image segmentation tasks include the task identifier of the images to be segmented.

The aforementioned “task identifier of the image to be segmented” is used to uniquely identify the image segmentation task (i.e., the aforementioned target segmentation task) to which the image to be segmented belongs.

The aforementioned “text embedding feature corresponding to the image to be segmented” is used to describe the task information and the class information corresponding to the image to be segmented.

In addition, the process of determining the aforementioned “text embedding feature corresponding to the image to be segmented” is similar to the process of determining the aforementioned “text embedding feature corresponding to the image to be processed”, and will not be repeated here for the sake of brevity.

S403: Determine a third mask extraction result of the image to be segmented using the mask extractor, the text embedding feature corresponding to the image to be segmented, and the image to be segmented. The aforementioned “third mask extraction result of the image to be segmented” is used to represent

a mask region predicted for the image to be segmented.

In addition, the content related to the aforementioned “third mask extraction result of the image to be segmented” is similar to the content related to the aforementioned “first mask extraction result of the image to be processed”, and will not be repeated here for the sake of brevity.

S404: Determine a segmentation result of the image to be segmented based on the third mask extraction result.

The aforementioned “segmentation result of the image to be segmented” is the result of image segmentation for the image to be segmented.

It should be noted that the implementation of S404 is not limited by the present application, and may specifically be, for example: determining the aforementioned third mask extraction result as the segmentation result of the image to be segmented. For another example, it may also be: performing a merge on the third mask extraction result and the image to be segmented to obtain a segmentation result of the image to be segmented, so that the segmentation result can represent the grouping of all pixels in the image to be segmented.

It should also be noted that the implementation of the step of “performing a merge on the third mask extraction result and the image to be segmented to obtain a segmentation result of the image to be segmented” in the preceding paragraph is not limited by the present application, and may be implemented using, for example, any existing or future method that can perform the determination of a segmentation result based on a mask.

Based on the content related to the aforementioned S401 to S404, it can be seen that, for the image segmentation method according to this embodiment of the present application, the image segmentation method is suitable for performing image segmentation for image data under several image segmentation tasks. Furthermore, the image segmentation method may specifically be: after the image to be segmented under the target segmentation task is obtained, a class label corresponding to the image to be segmented and a task identifier of the image to be segmented can be obtained first; the pre-constructed image segmentation model is then used to perform image segmentation for the image to be segmented, the class label corresponding to the image to be segmented, and the task identifier of the image to be segmented to obtain the segmentation result of the image to be segmented, so that the segmentation result can represent a mask region predicted for the image to be segmented. This can complete the mask extraction of image data under different image segmentation tasks using the same model, and is thus conducive to improving the effect of mask extraction.

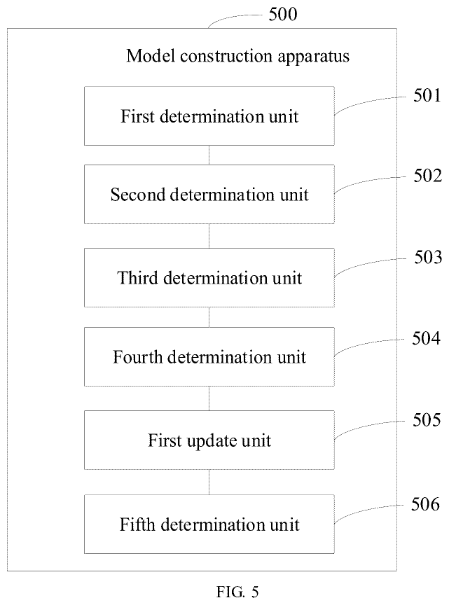

Based on the model construction method according to the embodiment of the present application, an embodiment of the present application also provides a model construction apparatus, which is explained and illustrated below in connection with FIG. 5. FIG. 5 is a schematic diagram of a structure of a model construction apparatus according to an embodiment of the present application. It should be noted that, for technical details of the model construction apparatus according to this embodiment of the present application, reference can be made to the content related to the aforementioned model construction method.

As shown in FIG. 5, a model construction apparatus 500 according to this embodiment of the present application includes:
a first determination unit 501 configured to determine an image to be processed from a training dataset, the training dataset including at least one first image that includes the image to be processed;
a second determination unit 502 configured to determine a first visual feature and a first mask extraction result of the image to be processed using a mask extractor;
a third determination unit 503 configured to determine a mask prediction loss based on the first mask extraction result and a mask label corresponding to the image to be processed;
a fourth determination unit 504 configured to determine a class prediction loss based on a similarity matching map between the first visual feature and a text embedding feature corresponding to the image to be processed, and a class label corresponding to the image to be processed, wherein the text embedding feature is determined based on a task identifier of the image to be processed and a class label corresponding to the at least one first image;
a first update unit 505 configured to update the mask extractor based on the mask prediction loss and the class prediction loss, and return to the first determination unit 501 to continue to perform the step of determining an image to be processed from a training dataset; and
a fifth determination unit 506 configured to determine an image segmentation model based on the mask extractor when a first stopping condition is met.

In a possible implementation, the mask label corresponding to the image to be processed is determined based on the task identifier of the image to be processed; and the task identifier of the image to be processed is determined from task identifiers of several image segmentation tasks.

In a possible implementation, the mask extractor includes an encoding network and a decoding network, the decoding network including a first decoding module, a second decoding module, and a prediction module; and

The second determination unit 502 includes:
a first encoding sub-unit configured to input the image to be processed into the mask extractor to obtain an encoding result output by the encoding network in the mask extractor;
a first decoding sub-unit configured to input the encoding result into the first decoding module to obtain a feature to be processed that is output by the first decoding module;
a semantic interaction sub-unit configured to perform semantic and contextual interaction on the feature to be processed and the text embedding feature to obtain the first visual feature of the image to be processed; and
a first determination sub-unit configured to determine the first mask extraction result of the image to be processed based on the first visual feature of the image to be processed, the second decoding module, and the prediction module.

In a possible implementation, the semantic interaction sub-unit is specifically configured to: perform the semantic and contextual interaction on the feature to be processed and the text embedding feature using a pre-constructed cross-attention module to obtain the first visual feature of the image to be processed.

In a possible implementation, the text embedding feature corresponding to the image to be processed is determined based on a text feature extraction module, the task identifier of the image to be processed, and the class label corresponding to the at least one first image; and the fifth determination unit 506 is specifically configured to: determine the image segmentation model based on the mask extractor and the text feature extraction module.

In a possible implementation, the text feature extraction module includes a prompt information generation network and a preset text encoder; and the class label corresponding to the at least one first image includes at least one class label to be processed; and the model construction apparatus 500 further includes:
a sixth determination unit configured to input the task identifier of the image to be processed into the prompt information generation network to obtain task prompt information that is output by the prompt information generation network; input each class label to be processed into the prompt information generation network to obtain class prompt information corresponding to the class label to be processed that is output by the prompt information generation network; input the task prompt information into the preset text encoder to obtain a task embedding feature output by the preset text encoder; input the class prompt information corresponding to the class label to be processed into the preset text encoder to obtain a class embedding feature corresponding to the class label to be processed that is output by the preset text encoder; concatenate the class embedding feature corresponding to the class label to be processed with the task embedding feature to obtain a concatenated result corresponding to the class label to be processed; and determine the text embedding feature corresponding to the image to be processed based on the concatenated result corresponding to the at least one class label to be processed.

In a possible implementation, the text feature extraction module includes a prompt information generation network and a preset text encoder; and the model construction apparatus 500 further includes:
a seventh determination unit configured to, after determining the image segmentation model based on the mask extractor and the text feature extraction module, determine an image to be used from a test dataset, the test dataset including at least one second image that includes the image to be used;
an eighth determination unit configured to determine, using the image segmentation model, a second mask extraction result of the image to be used and a text embedding feature corresponding to the image to be used;
a ninth determination unit configured to determine a second visual feature of the image to be used based on the image to be used, the second mask extraction result, and a preset visual encoder;
a tenth determination unit configured to determine an entropy loss based on a similarity matching map between the second visual feature and the text embedding feature corresponding to the image to be used, and at least one new class label, wherein the at least one new class label is determined based on a result of a comparison between the class label corresponding to the at least one first image and a class label corresponding to the at least one second image; and
a second update unit configured to update the prompt information generation network in the image segmentation model based on the entropy loss, and return to the seventh determination unit to continue to perform the step of determining an image to be used from a test dataset until a second stopping condition is met.

In a possible implementation, the second mask extraction result includes region representation results of several mask regions; and
the ninth determination unit is specifically configured to: extract a mask region image corresponding to each mask region from the image to be used based on a region representation result of the mask region; and input mask region images corresponding to the several mask regions into the preset visual encoder to obtain the second visual feature output by the preset visual encoder.

In a possible implementation, the second mask extraction result includes region representation results of several mask regions; and
the tenth determination unit is specifically configured to: obtain through filtering a similarity value corresponding to each new class label from the similarity matching map between the second visual feature and the text embedding feature corresponding to the image to be used to obtain a similarity set corresponding to each mask region, wherein the similarity set is used to record a similarity value corresponding to the mask region of each new class label; determine an entropy value corresponding to each mask region based on the similarity set corresponding to the mask region; select at least one target region from the several mask regions based on entropy values corresponding to the several mask regions, wherein an entropy value corresponding to the target region satisfies a preset entropy value condition; and determine the entropy loss based on a similarity set corresponding to the at least one target region.

In a possible implementation, the class prediction loss is determined based on a cross-entropy loss between the similarity matching map and the class label corresponding to the image to be processed.

Based on the content related to the aforementioned model construction apparatus 500, it can be seen that, for the model construction apparatus 500 according to this embodiment of the present application, a mask extractor is trained using a training dataset and mask labels that the training dataset has in several image segmentation tasks, so that the trained mask extractor has a good effect of mask extraction under all these image segmentation tasks. Thus, an image segmentation model constructed using the trained mask extractor has a good effect of image segmentation under all these image segmentation tasks, which in turn enables the image segmentation model to be suitable for image segmentation for image data under these image segmentation tasks. This makes the image segmentation model have a multi-image segmentation task processing function, so that the objective of completing multiple image segmentation tasks using one model can be achieved, which in turn is conducive to improving the effect of image segmentation.

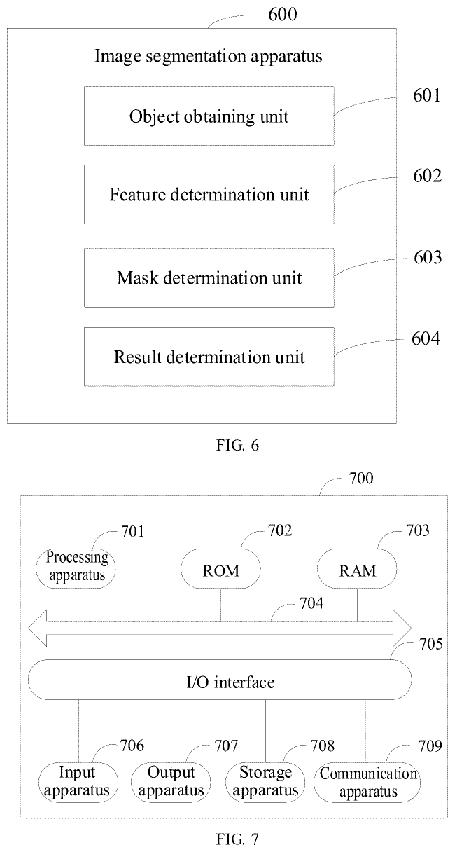

Based on the image segmentation method according to the embodiment of the present application, an embodiment of the present application also provides an image segmentation apparatus, which is explained and illustrated below in connection with FIG. 6. FIG. 6 is a schematic diagram of a structure of an image segmentation apparatus according to an embodiment of the present application. It should be noted that, for technical details of the image segmentation apparatus according to this embodiment of the present application, reference can be made to the content related to the aforementioned image segmentation method.

As shown in FIG. 6, an image segmentation apparatus 600 according to this embodiment of the present application includes:
an object obtaining unit 601 configured to obtain an image to be segmented, a class label corresponding to the image to be segmented, and a pre-constructed image segmentation model, wherein the image segmentation model includes a text feature extraction module and a mask extractor; and the image segmentation model is configured to perform image segmentation for image data under several image segmentation tasks;
a feature determination unit 602 configured to determine a text embedding feature corresponding to the image to be segmented using the text feature extraction module, a task identifier of the image to be segmented, and the class label corresponding to the image to be segmented, wherein task identifiers of the several image segmentation tasks include the task identifier of the images to be segmented;
a mask determination unit 603 configured to determine a third mask extraction result of the image to be segmented using the mask extractor, the text embedding feature corresponding to the image to be segmented, and the image to be segmented; and
a result determination unit 604 configured to determine a segmentation result of the image to be segmented based on the third mask extraction result.

Based on the content related to the aforementioned image segmentation apparatus 600, it can be seen that, for the image segmentation apparatus 600 according to this embodiment of the present application, the image segmentation apparatus 600 is suitable for performing image segmentation for image data under several image segmentation tasks. Furthermore, the working principle of the image segmentation apparatus 600 may specifically be: after the image to be segmented under the target segmentation task is obtained, a class label corresponding to the image to be segmented and a task identifier of the image to be segmented can be obtained first; the pre-constructed image segmentation model is then used to perform image segmentation for the image to be segmented, the class label corresponding to the image to be segmented, and the task identifier of the image to be segmented to obtain the segmentation result of the image to be segmented, so that the segmentation result can represent a mask region predicted for the image to be segmented. This can complete the mask extraction of image data under different image segmentation tasks using the same model, and is thus conducive to improving the effect of mask extraction.

In addition, an embodiment of the present application further provides an electronic device. The device includes a processor and a memory, wherein the memory is configured to store instructions or a computer program; and the processor is configured to execute the instructions or the computer program in the memory to cause the electronic device to perform any implementation of the model construction method or the image segmentation method according to an embodiment of the present application.

Reference is made to FIG. 7, which is a schematic diagram of a structure of an electronic device 700 suitable for implementing embodiments of the present disclosure. Terminal devices in embodiments of the present disclosure may include, but are not limited to, mobile terminals such as cell phones, laptop computers, digital broadcast receivers, personal digital assistants (PDAs), tablet computers (PADs), portable multimedia players (PMPs), in-vehicle terminals (e.g., in-vehicle navigation terminals), and so on, and fixed terminals such as digital TVs, desktop computers, and so on. The electronic device shown in FIG. 7 is merely an example, and shall not impose any limitation on the function and scope of use of embodiments of the present disclosure.

As shown in FIG. 7, the electronic device 700 may include a processing apparatus (e.g., a central processing unit or a graphics processing unit) 701 that may perform a variety of appropriate actions and processing in accordance with a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to each other through a bus 704. An input/output (I/O) interface 705 is also connected to the bus 704.

Generally, the following apparatuses may be connected to the I/O interface 705: an input apparatus 706 including, for example, a touchscreen, a touchpad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a tape and a hard disk; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, wherein the computer program includes program code for performing the method shown in the flowchart. In such an embodiment, the computer program may be downloaded and installed from a network through the communication apparatus 709, installed from the storage apparatus 708, or installed from the ROM 702. When the computer program is executed by the processing apparatus 701, the above-mentioned functions defined in the methods of embodiments of the present disclosure are performed.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of the present application further provides a computer-readable medium, wherein the computer-readable medium stores instructions or a computer program that, when run on a device, cause the device to execute any implementation of the model construction method or the image segmentation method according to embodiments of the present application.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory

(RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server may communicate using any currently known or future developed network protocol such as HTTP (Hyper Text Transfer Protocol) and may be interconnected with digital data communications (e.g., communication networks) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device.

Alternatively, the computer-readable medium may exist independently, without being assembled into the electronic device.

The above computer-readable medium carries one or more programs that, when executed by the electronic device, cause the electronic device to perform the method described above.

Computer program code for performing operations of the present disclosure can be written in one or more programming languages or a combination thereof, wherein the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof.

More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on the differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present application, “at least one” means one or more, and “multiple” means two or more. The term “and/or” is used to describe an association relationship between associated objects, and indicates that three relationships may exist, for example, A and/or B may indicate that: only A exists, only B exists, and both A and B exist, wherein A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, and c, “a and b”, “a and c”, “b and c”, or “a and b and c”, wherein a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include” and “comprise”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

With respect to the above description of the disclosed embodiments, those skilled in the art could implement or use the present application. Various modifications to these embodiments are apparent to those skilled in the art, and the general principle defined herein may be practiced in other embodiments without departing from the spirit or scope of the present application. Therefore, the present application is not limited to the embodiments described herein but is to be accorded with the broadest scope consistent with the principle and novel features disclosed herein.

1. A model construction method, comprising:
determining an image to be processed from a training dataset, the training dataset comprising at least one first image comprising the image to be processed;
determining a first visual feature and a first mask extraction result of the image to be processed using a mask extractor;
determining a mask prediction loss based on the first mask extraction result and a mask label corresponding to the image to be processed;
determining a class prediction loss based on a similarity matching map between the first visual feature and a text embedding feature corresponding to the image to be processed, and a class label corresponding to the image to be processed, wherein the text embedding feature is determined based on a task identifier of the image to be processed and a class label corresponding to the at least one first image; and
updating the mask extractor based on the mask prediction loss and the class prediction loss, and continuing to perform the step of determining an image to be processed from the training dataset until a first stopping condition is met, and determining an image segmentation model based on the mask extractor.

2. The method of claim 1, wherein the mask label corresponding to the image to be processed is determined based on the task identifier of the image to be processed; and
the task identifier of the image to be processed is determined from task identifiers of several image segmentation tasks.

3. The method of claim 1, wherein the mask extractor comprises an encoding network and a decoding network, the decoding network comprising a first decoding module, a second decoding module, and a prediction module; and
determining the first visual feature and the first mask extraction result of the image to be processed using the mask extractor comprises:
inputting the image to be processed into the mask extractor to obtain an encoding result output by the encoding network in the mask extractor;
inputting the encoding result into the first decoding module to obtain a feature to be processed that is output by the first decoding module;
performing semantic and contextual interaction on the feature to be processed and the text embedding feature to obtain the first visual feature of the image to be processed; and
determining the first mask extraction result of the image to be processed based on the first visual feature of the image to be processed, the second decoding module, and the prediction module.

4. The method of claim 3, wherein performing the semantic and contextual interaction on the feature to be processed and the text embedding feature to obtain the first visual feature of the image to be processed comprises:
performing the semantic and contextual interaction on the feature to be processed and the text embedding feature using a pre-constructed cross-attention module to obtain the first visual feature of the image to be processed.

5. The method of claim 1, wherein the text embedding feature corresponding to the image to be processed is determined based on a text feature extraction module, the task identifier of the image to be processed, and the class label corresponding to the at least one first image;
determining the image segmentation model based on the mask extractor comprises:
determining the image segmentation model based on the mask extractor and the text feature extraction module.

6. The method of claim 5, wherein the text feature extraction module comprises a prompt information generation network and a preset text encoder; and the class label corresponding to the at least one first image comprises at least one class label to be processed;
a process of determining the text embedding feature corresponding to the image to be processed comprises:
inputting the task identifier of the image to be processed into the prompt information generation network to obtain task prompt information output by the prompt information generation network;
inputting each class label to be processed into the prompt information generation network to obtain class prompt information corresponding to the class label to be processed that is output by the prompt information generation network;
inputting the task prompt information into the preset text encoder to obtain a task embedding feature output by the preset text encoder;
inputting the class prompt information corresponding to the class label to be processed into the preset text encoder to obtain a class embedding feature corresponding to the class label to be processed that is output by the preset text encoder;
concatenating the class embedding feature corresponding to the class label to be processed with the task embedding feature to obtain a concatenated result corresponding to the class label to be processed; and
determining the text embedding feature corresponding to the image to be processed based on the concatenated result corresponding to the at least one class label to be processed.

7. The method of claim 5, wherein the text feature extraction module comprises a prompt information generation network and a preset text encoder;
after determining the image segmentation model based on the mask extractor and the text feature extraction module, the method further comprises:
determining an image to be used from a test dataset, the test dataset comprising at least one second image comprising the image to be used;
determining, using the image segmentation model, a second mask extraction result of the image to be used and a text embedding feature corresponding to the image to be used;
determining a second visual feature of the image to be used based on the image to be used, the second mask extraction result, and a preset visual encoder;
determining an entropy loss based on a similarity matching map between the second visual feature and the text embedding feature corresponding to the image to be used, and at least one new class label, wherein the at least one new class label is determined based on a result of a comparison between the class label corresponding to the at least one first image and a class label corresponding to the at least one second image; and
updating the prompt information generation network in the image segmentation model based on the entropy loss, and continuing to perform the step of determining an image to be used from the test dataset until a second stopping condition is met.

8. The method of claim 7, wherein the second mask extraction result comprises region representation results of several mask regions;
a process of determining the second visual feature of the image to be used comprises:
extracting a mask region image corresponding to each mask region from the image to be used based on a region representation result of the mask region; and
inputting mask region images corresponding to the several mask regions into the preset visual encoder to obtain the second visual feature output by the preset visual encoder.

9. The method of claim 7, wherein the second mask extraction result comprises region representation results of several mask regions;
a process of determining the entropy loss comprises:
obtaining through filtering a similarity value corresponding to each new class label from the similarity matching map between the second visual feature and the text embedding feature corresponding to the image to be used to obtain a similarity set corresponding to each mask region, wherein the similarity set is used to record a similarity value corresponding to the mask region of each new class label;
determining an entropy value corresponding to each mask region based on the similarity set corresponding to the mask region;
selecting at least one target region from the several mask regions based on entropy values corresponding to the several mask regions, wherein an entropy value corresponding to the target region satisfies a preset entropy value condition; and
determining the entropy loss based on a similarity set corresponding to the at least one target region.

10. The method of claim 1, wherein the class prediction loss is determined based on a cross-entropy loss between the similarity matching map and the class label corresponding to the image to be processed.

11. An image segmentation method, comprising:
obtaining an image to be segmented, a class label corresponding to the image to be segmented, and a pre-constructed image segmentation model, wherein the image segmentation model comprises a text feature extraction module and a mask extractor; and the image segmentation model is configured to perform image segmentation for image data under several image segmentation tasks;
determining a text embedding feature corresponding to the image to be segmented using the text feature extraction module, a task identifier of the image to be segmented, and the class label corresponding to the image to be segmented, wherein task identifiers of the several image segmentation tasks comprise the task identifier of the images to be segmented;
determining a third mask extraction result of the image to be segmented using the mask extractor, the text embedding feature corresponding to the image to be segmented, and the image to be segmented; and
determining a segmentation result of the image to be segmented based on the third mask extraction result.

12. (canceled)

13. (canceled)

14. An electronic device, comprising: a processor and a memory, wherein
the memory is configured to store instructions or a computer program; and
the processor is configured to execute the instructions or the computer program in the memory to cause the electronic device to perform;
determine an image to be processed from a training dataset, the training dataset comprising at least one first image comprising the image to be processed;
determine a first visual feature and a first mask extraction result of the image to be processed using a mask extractor;
determine a mask prediction loss based on the first mask extraction result and a mask label corresponding to the image to be processed;
determine a class prediction loss based on a similarity matching map between the first visual feature and a text embedding feature corresponding to the image to be processed, and a class label corresponding to the image to be processed, wherein the text embedding feature is determined based on a task identifier of the image to be processed and a class label corresponding to the at least one first image; and
update the mask extractor based on the mask prediction loss and the class prediction loss, and continuing to perform the step of determining an image to be processed from the training dataset until a first stopping condition is met, and determining an image segmentation model based on the mask extractor.

15. (canceled)

16. The electronic device of claim 14, wherein the mask extractor comprises an encoding network and a decoding network, the decoding network comprising a first decoding module, a second decoding module, and a prediction module; and
the electronic device is caused to determine the first visual feature and the first mask extraction result of the image to be processed using the mask extractor by:
inputting the image to be processed into the mask extractor to obtain an encoding result output by the encoding network in the mask extractor;
inputting the encoding result into the first decoding module to obtain a feature to be processed that is output by the first decoding module;
performing semantic and contextual interaction on the feature to be processed and the text embedding feature to obtain the first visual feature of the image to be processed; and
determining the first mask extraction result of the image to be processed based on the first visual feature of the image to be processed, the second decoding module, and the prediction module.

17. The electronic device of claim 16, wherein the electronic device is caused to perform the semantic and contextual interaction on the feature to be processed and the text embedding feature to obtain the first visual feature of the image to be processed by:
performing the semantic and contextual interaction on the feature to be processed and the text embedding feature using a pre-constructed cross-attention module to obtain the first visual feature of the image to be processed.

18. The electronic device of claim 14, wherein the text embedding feature corresponding to the image to be processed is determined based on a text feature extraction module, the task identifier of the image to be processed, and the class label corresponding to the at least one first image;
the electronic device is caused to determine the image segmentation model based on the mask extractor by:
determining the image segmentation model based on the mask extractor and the text feature extraction module.

19. The electronic device of claim 18, wherein the text feature extraction module comprises a prompt information generation network and a preset text encoder; and the class label corresponding to the at least one first image comprises at least one class label to be processed;
the electronic device is caused to determine the text embedding feature corresponding to the image to be processed by:
inputting the task identifier of the image to be processed into the prompt information generation network to obtain task prompt information output by the prompt information generation network;
inputting each class label to be processed into the prompt information generation network to obtain class prompt information corresponding to the class label to be processed that is output by the prompt information generation network;
inputting the task prompt information into the preset text encoder to obtain a task embedding feature output by the preset text encoder;
inputting the class prompt information corresponding to the class label to be processed into the preset text encoder to obtain a class embedding feature corresponding to the class label to be processed that is output by the preset text encoder;
concatenating the class embedding feature corresponding to the class label to be processed with the task embedding feature to obtain a concatenated result corresponding to the class label to be processed; and
determining the text embedding feature corresponding to the image to be processed based on the concatenated result corresponding to the at least one class label to be processed.

20. The electronic device of claim 18, wherein the text feature extraction module comprises a prompt information generation network and a preset text encoder;
after determining the image segmentation model based on the mask extractor and the text feature extraction module, the electronic device is further caused to:
determine an image to be used from a test dataset, the test dataset comprising at least one second image comprising the image to be used;
determine, using the image segmentation model, a second mask extraction result of the image to be used and a text embedding feature corresponding to the image to be used;
determine a second visual feature of the image to be used based on the image to be used, the second mask extraction result, and a preset visual encoder;
determine an entropy loss based on a similarity matching map between the second visual feature and the text embedding feature corresponding to the image to be used, and at least one new class label, wherein the at least one new class label is determined based on a result of a comparison between the class label corresponding to the at least one first image and a class label corresponding to the at least one second image; and
update the prompt information generation network in the image segmentation model based on the entropy loss, and continuing to perform the step of determining an image to be used from the test dataset until a second stopping condition is met.

21. The electronic device of claim 20, wherein the second mask extraction result comprises region representation results of several mask regions;
the electronic device is caused to determine the second visual feature of the image to be used by:
extract a mask region image corresponding to each mask region from the image to be used based on a region representation result of the mask region; and
input mask region images corresponding to the several mask regions into the preset visual encoder to obtain the second visual feature output by the preset visual encoder.

22. The electronic device of claim 20, wherein the second mask extraction result comprises region representation results of several mask regions;
the electronic device is caused to determine the entropy loss by:
obtaining through filtering a similarity value corresponding to each new class label from the similarity matching map between the second visual feature and the text embedding feature corresponding to the image to be used to obtain a similarity set corresponding to each mask region, wherein the similarity set is used to record a similarity value corresponding to the mask region of each new class label;
determining an entropy value corresponding to each mask region based on the similarity set corresponding to the mask region;
selecting at least one target region from the several mask regions based on entropy values corresponding to the several mask regions, wherein an entropy value corresponding to the target region satisfies a preset entropy value condition; and
determining the entropy loss based on a similarity set corresponding to the at least one target region.
